(19) United States
(12) Patent Application Publication
(10) Pub. No.: US 2006/0277482 A1
(43) Pub. Date: Dec. 7, 2006

(54) METHOD AND APPARATUS FOR AUTOMATICALLY STORING AND RETRIEVING SELECTED DOCUMENT SECTIONS AND USER-GENERATED NOTES

(75) Inventors: Marcia Hoffman, Hollywood, FL (US); Daniel Goodman, N. Miami Beach, FL (US); Mitchell D. Mittman, FT. LAUDERDALE, FL (US)

Correspondence Address: ANTHONY R. BARKUME, 20 GATEWAY LANE, MANORVILLE, NY, 11949, US

(73) Assignee: ILIGHTER CORP., Ft. Lauderdale, FL (US)

(21) Appl. No.: 11/422,742

(22) Filed: Jun. 7, 2006

Related U.S. Application Data
(60) Provisional application No. 60/688,390, filed on Jun. 7, 2005.

(51) Int. Cl. G06F 3/00; G06F 17/00; G06F 7/00

(52) U.S. Cl. 715/764; 715/770; 707/100

(57) ABSTRACT

A method for selecting and saving information in a single user action. A user selects, with a computer input device such as a mouse, a document section having text and/or images from a primary document such as a web page displayed in a window of a primary document display program such as a web browser associated with a document section acquisition program. The selected document section is automatically, with no further user action required, transmitted over a network to a server computer and stored. Multiple document sections from one or more primary documents may be similarly stored. The document sections may then be transmitted to a document viewing program and displayed in a document viewer window. The user may select which document sections to retrieve and display, which are then assembled into a document at the document viewing program. Notes may also be added by the user in association with a selected document section. The assembled document may be saved as a scrapbook, printed, sent to a word processing program, and the like.

### CROSS-REFERENCE TO RELATED APPLICATION

This application is based on and claims filing priority from co-pending U.S. provisional application No. 60/688,390, filed Jun. 7, 2005, the specification of which is incorporated by reference herein.

### TECHNICAL FIELD

The field of the invention relates to selecting and automatically saving on a central server specified sections of electronic documents, and then retrieving those document sections to assemble new documents suitable for printing, saving, sharing with others, and the like.

### BACKGROUND ART

At work and at home, the Internet floods us with vast amounts of information. Without leaving the computer, people have access to almost anything: news, entertainment, shopping, financial, legal, and medical research. When we want to know something or get something we don't hesitate to use a commercial search engine such as GOOGLE.

THE WALL STREET JOURNAL, THE NEW YORK TIMES, or BUSINESS WEEK are all online. WEBMD, PUBMED, HOOVERS, LEXIS/NEXIS and WESTLAW are primary research tools. GOOGLE is scanning the world's libraries and MICROSOFT is digitizing the world's art galleries. Each day more and better information is available to us.

We live on the computer today. Information we need that isn't on the computer easily be digitized and uploaded. If its not on the computer we can get it there. Scan pens using optical character recognition enable us to convert anything we find on paper into computer text. While away from the PC, digital pens enable us to handwrite notes which are captured in the pen's memory and converted using handwriting recognition into electronic text for use on the computer. We can dictate notes into digital audio recorders, which are then converted to text using speech recognition software.

Computer text is all around us; it has become the coin of the realm in our information economy. We've all been transformed into knowledge workers and this is a double edged sword. We are forced to sift through increasing volumes of data originating from an increasing number of sources, both online and off the computer. To find important data we must read through pages to find paragraphs, often using only sentences from each.

The problem we face today is managing all this information. Selecting, saving and organizing only relevant data is difficult. Locating saved information (a section of a web page, a paragraph from a newsletter, a portion of an email, a few notes from an online article) can be an exercise in frustration.

Ideally, there should be a simple way to select and automatically save only relevant pieces of information; easily access and retrieve that saved information from any PC, laptop, PDA or mobile phone; maximize the utility of this saved information by having a simple method of emailing, posting to a blog or inserting it into an existing document; and share collected information with others in a safe, secure and expandable environment.

### DISCLOSURE OF THE INVENTION

It is an object of the present invention to provide an efficient, user-friendly method of saving selected sections of text and images from electronic documents, and adding user-generated notes or annotations in association with those saved document sections. It is a further object of this invention to provide a user with the ability to make a document section selection and have it automatically transmitted to a centrally located server computer for storage and later retrieval in a simple, single user-action such as by simply blocking a desired section of text with a single mouse click.

The present invention in its totality may be referred to throughout this document as an intelligent document section management system, known commercially as I-LIGHTER™. The present invention allows users of a number of popular document-viewing software programs (such as MICROSOFT INTERNET EXPLORER, FIREFOX, ADOBE ACROBAT Reader, and MICROSOFT OFFICE) to effectively save selected document sections, add user-defined notes, and share them in a new and innovative way. The present invention automatically stores selected sections of the documents, and allows users to easily share their stored document sections with others.

In a preferred embodiment, all selected document sections and user-generated notes are stored on a centralized server computer, and users can search the central database of saved information. The present invention also provides features facilitating the delivery of contextual advertising based on particular likely interests, derived from an automated analysis of user's highlighted text, the user's patterns of sharing document sections with other users, and the user's searches of the database.

The present invention adds a document section selection feature to third-party software such as INTERNET EXPLORER, FIREFOX, OFFICE, and ACROBAT Reader, such that a user may select and highlight portions of a primary document (including text and graphics) within that third-party software, attach and integrate user-generated notes associated with the selected document section, and save and share these pieces of information. The term “highlighted text” as used in this document shall be construed to include highlighted graphics as well as text. The term “annotate” as used in this document includes the functions of generating and attaching notes to a selected document section.

The present invention allows document sections to be selected, saved, and retrieved via any networked user device such as a PC, wirelessly connected laptop computer or PDA, web-enabled cell phone, etc. In a preferred embodiment, document section saving occurs automatically and dynamically to a centralized server database as highlighting is added (or removed), and each time a written note is entered.

One aspect of the present invention allows users to save selected document sections to a variety of folders, and optionally to set sharing permissions separately on these folders such that different folders may be accessed by different individuals and groups.

In a preferred Internet embodiment, use of the system is free to individuals, and document sections selected according to the present invention are saved in a central web server database. User contact lists may be imported (from common contact databases such as MICROSOFT OUTLOOK) to the user's area of the central server, and links to user-selected saved document sections may be shared with contacts through a simple process which sends e-mail containing document links.

Thus, in a preferred embodiment described further herein, the present invention provides a method of and system for selecting and saving information in a single user action. First, a user selects, with a computer input device (i.e. a pointing device such as a mouse, trackball, touchpad or the like), a document section from a primary document (such as a web page) displayed in a window of a primary document display program (such as a web browser) associated with a document section acquisition program of the present invention. A data structure is then assembled in memory (e.g. RAM) of the document section acquisition program that includes the selected document section. The data structure may then be automatically transmitted over a computer network from the document section acquisition program on the user device to a server computer, where data from the data structure is then automatically stored on a nonvolatile storage medium such as a hard disk. The selected document section may include text and/or images, along with the appropriate formatting automatically obtained from the primary document.

Notably, the document section is selected by the user and automatically stored on the remote storage in a single user action, such as when the user uses the pointing device to place a cursor at a start location of the desired document section, then clicks an input button on the pointing device to begin the selection of the document section and drags the pointing device so that the document section is blocked out on the computer screen, and then releases the input button on the pointing device. As such, the selected document section is automatically assembled into the data structure and transmitted over the computer network to the server computer as a direct result of releasing the input button on the pointing device, and without requiring further action by the user such as a drag and drop motion, pointing to a desired folder, and the like.

At some point after one or more document sections have been selected and stored at the server, they may be transmitted to a document viewing program executing on a user client computing device (which may be the same computing device that is running the document section acquisition program or a different computing device) and then displayed in a document viewer window associated with the document viewing program.

In addition, a user may generate, in association with a selected document section in the primary document, a note comprising textual input. A data structure including the note is assembled in memory and automatically transmitted over the computer network to the server computer and stored on the nonvolatile storage medium in association with the stored selected document section. Furthermore, the document section and the associated note may be transmitted from the storage medium to the document viewing program and displayed in the document viewer window associated with the document viewing program. A note display control function may be provided in association with the document viewer window, which enables the user to selectively configure the note display control function to disable display of the note while continuing to display the associated document section in the document viewer window, and/or selectively configure the note display control function to enable display of the note while continuing to display the associated document section in the document viewer window. In addition, the user may revise the note displayed in the document viewer window at the document viewing program, and as a result, the revised note is transmitted to the server computer and stored on the storage medium in association with the stored document section. Likewise, a user may revise the note displayed in the primary document at the document section acquisition program, whereby the revised note is transmitted to the server computer and stored on the storage medium in association with the stored document section. Subsequent notes including additional text input by the user may be assembled into a data structure in memory, transmitted to the server computer, and then stored on the nonvolatile storage medium in association with the stored selected document section.

The data structure may include a record ID, wherein data from the data structure is stored on the storage medium to create a database record associated with the record ID. A user may then select a subsequent document section from the primary document, and then a subsequent data structure is assembled in memory that includes the subsequent document section and the record ID. The subsequent data structure is then transmitted over the computer network to the server computer, and data from the subsequent data structure is stored in the database record associated with the record ID.

When the user makes the first document section selection from a primary document, a record ID request is transmitted by the document section acquisition program to the server computer. The server computer will generate a record ID and provide the record ID to the document section acquisition program for use as described herein.

At the server computer, a plurality of database records may be created and associated with the user on the storage medium, wherein each database record is associated with a unique record ID and includes a document section selected from one of a plurality of different primary documents and a document title uniquely identifying the document section. As such, the document titles are transmitted from each of the plurality of records associated with the user to the document viewing program, where the document titles are then displayed in a document selection window associated with the document viewing program.

In one aspect of the invention, a search control function window is provided in association with the document viewing program. The user may then selectively enter a search term into the search control function window, and a search engine running in association with the server computer uses the search term to execute a search of any one or more of: the document titles, the document sections, or the associated notes, as selected by the user from the search control function window. The search engine generates a list of matched document titles having criteria matching the search term as specified by the user, and then sends the list of matched document titles to the document viewing program for display in the document selection window.

A folder nomenclature may be implemented, wherein a folder name is stored in each database record, the folder name being identified by the user as being associated with the document title in the record. The folder name may be transmitted with the associated document title and displayed in a folder tree format in a folder display window associated with the document viewing program. As such, the document titles are then displayed in the document selection window in accordance with their associated folder names.

The user may select a plurality of document titles from the document selection window, and then for each document title selected by the user, a document request is sent to the server computer for the document section associated with the document title in the storage medium. For each document request, the server computer sends the requested document section to the document viewing program, and the document sections received from the server computer are consecutively displayed as an assembled document in the document viewer window.

Each record may further include a document location address such as a URL hyperlink or a local pathname that indicates the location of the primary document associated with the document section. This enables the user to select the document location address and retrieve the primary document stored at that location.

A document map may be provided, which is viewable by the user in association with the document viewing program. The document map includes a list of the titles of the document sections selected by the user and contained in the assembled document displayed in the document viewer window. The user may change the order of the selected document sections displayed in the assembled document by selecting one or more document order controls displayed with the document map. The user may also remove at least one of the selected document sections displayed in the assembled document by selecting a remove or delete function displayed with the document map. In addition, the user may remove at least one of the selected document sections displayed in the assembled document by unselecting the associated document title from the document selection window.

The user may save a scrapbook of the assembled document. The scrapbook includes a list of each document title selected by the user and comprised in the assembled document, and it is saved in a record associated with the user and stored in the storage medium at the server computer. The user may open a previously saved scrapbook by selecting a scrapbook title from a list of available scrapbooks previously saved and displayed to the user in association with the document viewing program. In this event, a list of document titles are displayed from the selected scrapbook, and a document is dynamically generated in the document viewer window by sending a document section request to the server computer for the document section associated with each document title in the storage medium, and for each document section request, the server computer sending the requested document section to the document viewing program, and then consecutively displaying each document section received from the server computer in the document viewer window as the assembled document.

The assembled document may be sent to a word processing program, or published to a web site adapted to a dynamically accept text and images (such as a blog), inserted in to an email message, or printed.

As further described herein, the present invention is an online service that provides a single-step solution. It seamlessly integrates its features into existing document display programs such as INTERNET EXPLORER, FIREFOX, ADOBE ACROBAT, and MICROSOFT OFFICE.

### BRIEF DESCRIPTION OF THE DRAWING

FIG. 1 is a system level functional block diagram of a preferred embodiment of the present invention.

FIG. 2 is a functional diagram of the document section acquisition process of the present invention.

FIG. 3 is an exemplary screen shot illustration of the document viewing program of the present invention.

FIG. 4 illustrates a screen shot of a primary document and the document section selection menu of the present invention.

FIG. 5 illustrates a screen shot of a primary document with a document section selected.

FIG. 6 illustrates the Change Folder menu of the present invention.

FIG. 7 illustrates a screen shot of a primary document with multiple document sections selected.

FIG. 8 illustrates a screen shot of a primary document with a note added.

FIG. 9 illustrates the email functionality of the document section acquisition program.

FIG. 10 illustrates a screen shot of the email of FIG. 9.

FIG. 11 illustrates a detailed screen shot of the document viewing program of the present invention.

FIG. 12 illustrates a detailed screen shot of the document viewing program of the present invention with multiple documents selected for viewing.

FIG. 13 is an illustration of the document map feature of the present invention.

FIGS. 14 and 15 illustrate a Share Folder window of the present invention.

FIG. 16 illustrates a Search Menu window of the present invention.

FIG. 17 illustrates the search results window of the present invention.

FIG. 18 shows a more detailed block diagram of a user device of FIG. 1.

FIG. 19 is a basic flowchart of the document section acquisition process of the present invention.

FIG. 20 is a more detailed flowchart of FIG. 19.

FIG. 21 is a detailed flowchart of the document section viewing functionality of the present invention.

FIG. 22 is a flowchart of the contextual advertising embodiment of the present invention.

### BEST MODE FOR CARRYING OUT THE INVENTION

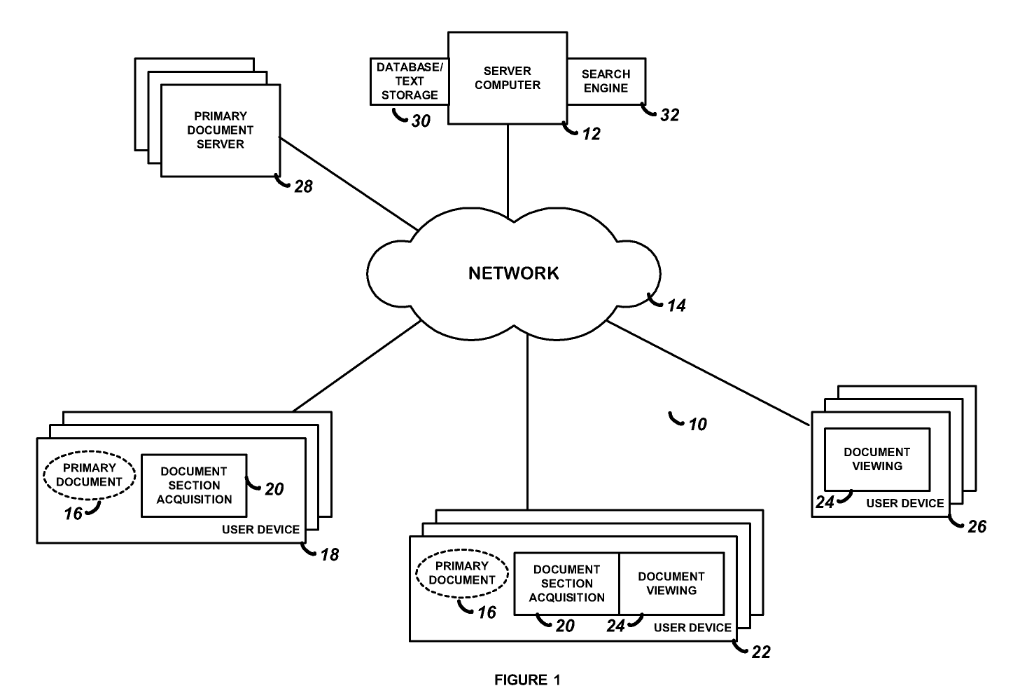

FIG. 1 illustrates a top-level system block diagram of a preferred embodiment 10 of the present invention. There are three main functions of the present invention: document section acquisition, document section storage and retrieval, and document section viewing. A central server computer 12 is adapted to communicate over a computer network 14 with a multiplicity of user client computing devices, which include user client devices 18 running a document section acquisition program 20 in conjunction with a primary document display program 16, user client devices 26 running a document viewing program 24, and user client devices 22 running both a document section acquisition program 20 (along with a primary document display program 16) and a document viewing program 24. In a typical embodiment, the server computer 12 communicates with the user client devices 18, 26 and 22 over a wide area network 14 such as the Internet, although the present invention also may function over a local area network (LAN) as adapted by the present invention. FIG. 1 also illustrates a primary document server computer 28 interconnected to the network 14, which typically will be a web server as well known in the art that serves web pages used as primary documents from which document sections will be selected as described herein. The primary document server need not be especially adapted in order to operate with the present invention and need only serve the function of providing the primary documents as desired by a user. While the preferred embodiment envisions that the document section acquisition program 20, document viewing program 24, server computer 12, and primary document server 28 exist on separate computing devices, the functions implemented by these components may be executed on the same computing device if desired, in any combination, as further described herein.

In the preferred embodiment, the user client device 18 that runs the document section acquisition program 20 will be a personal computer running any operating system, such as WINDOWS XP, LINUX, and the like. The primary document display program 16 is a web browser such as INTERNET EXPLORER, but may in alternative embodiments be programs such as ADOBE ACROBAT, MICROSOFT WORD, and the like. One key aspect of the present invention is the ease with which a user can use a computer input device to select the desired document section from a primary document displayed via the primary document display program 16 in the computer screen with a single user action. Typically, the user will implement this functionality with a pointing device such as a mouse, but the present invention may operate with other pointing devices including trackballs, trackpads, pen inputs, touchscreens, and the like. The user client device will also have appropriate memory such as nonvolatile RAM into which selected document sections are automatically loaded as a result of the single user action, as well as communications circuitry such as a network interface or the like for automatically sending the selected document sections to the server computer 12 for storage therein as will be further described.

Likewise, a typical user client device 26 that runs the document viewing program 24 will be a personal computer having a display screen and input devices, as well as communication circuitry for communicating with the server computer 12 over the network 14 as will be further described. The present invention also envisions that the user client device 26 may be portable devices such as PDAs and the like that may be adapted in accordance with the present invention.

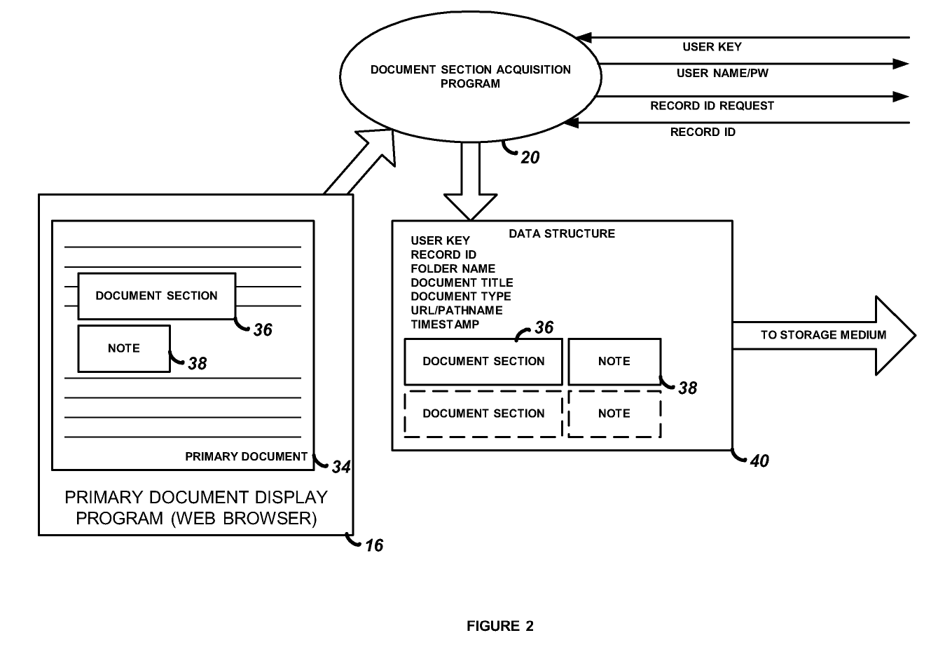

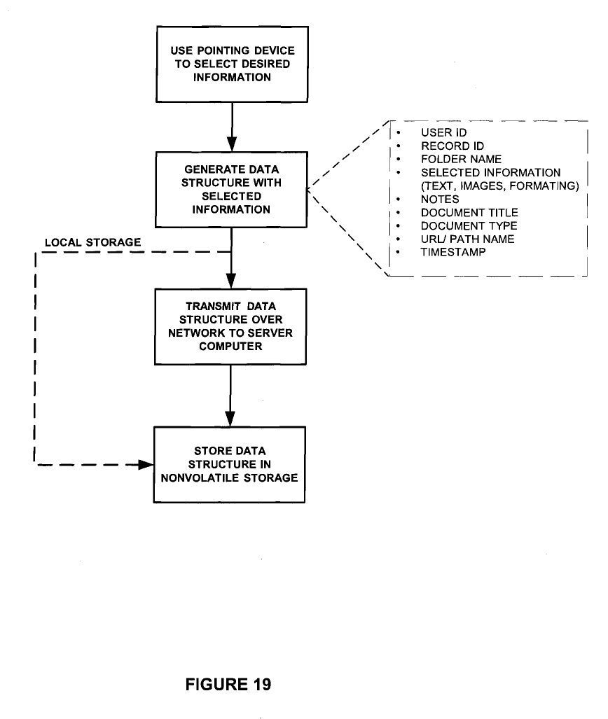

FIG. 2 illustrates a functional block diagram of the document section acquisition process. As indicated, the document section acquisition program 20 runs in conjunction with the primary document display program 16 (referred to also herein as a web browser). A user views a primary document 34 (a web page) on the web browser, the web page having been downloaded for viewing from a primary document server 28 over the network 14 as well known in the art. The user decides that a section or sections of the web page should be stored for later use, and will then begin the process of selecting the desired information and sending that information to the server computer 12 for storage therein, all with a single user action. Once the user has enabled the document section selection process of the present invention (for example with a toolbar selection as described further herein), also referred to as using the I-LIGHTING™ functionality, he will then use the mouse to make a document section selection. The user places the cursor at a start location of the desired document section, then clicks an input button on the pointing device (e.g. left or normal click) to begin the selection of the document section and drags the pointing device so that the document section is blocked out on the computer screen, and then releases the input button on the pointing device. On release of the mouse button, the selected document section 36 is then automatically copied into a data structure 40 in memory, which will contain additional information as further described. The data structure 40 will then be automatically transmitted to the server computer 12 for storage therein in nonvolatile storage such as a hard disk drive. FIG. 19 also shows the functional flow of this process.

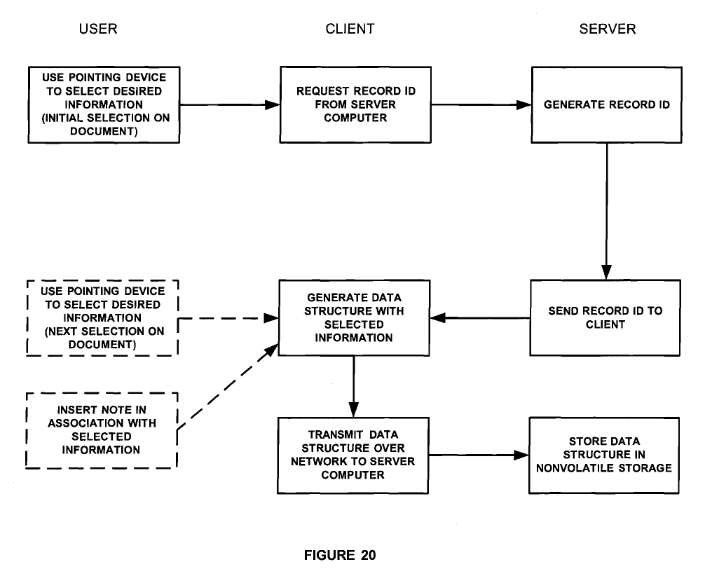

With further reference to the flowchart of FIG. 20, when the user makes the first selection of a document section 36 from a primary document 34, a record ID request message is transmitted by the document section acquisition program 20 to the server computer 12. The server computer will receive the record ID request message and as a result will generate a record ID and provide the record ID back to the document section acquisition program 20. The record IDs generated and issued by the server computer 12 are unique, since the record ID is the key to storing each data record in the database as further described.

After the document section acquisition program 20 receives the requested record ID, it will assemble the data structure 40 that includes the record ID and the document section 36 as selected by the user. In addition, a user key, which uniquely identifies the current user, is in the data structure. A folder name (which is initially a default folder name, further described herein) is also included in the data structure as further described below. Other items that are in the data structure include a document title, which may by default be the existing title of the primary document or which may be modified by the user, a document type that identifies the type of primary document 34 such as a web page, and a timestamp that identifies the time and date of the document section selection by the user. Also included in the data structure will be a document location address indicating the location of the primary document 34, such as a URL (if the primary document 34 is a web page from a remote primary document server 28) or a local pathname (if the primary document is obtained locally from a drive on the user computer). An additional component of the data structure may be a note 38, (also referred to as an I-NOTE™), as further described below.

The user may make subsequent selections of document sections 36 from the same primary document 34 while that primary document is displayed in the primary document display program 16. When the user makes a subsequent selection of a document section from the same primary document 34, then the same record ID is used by the document section acquisition program 20 to generate a data structure as shown in FIG. 2. The data structure will again include the user key, record ID, folder name, document title, document type, and document location address, as well as the current timestamp. As previously described, upon release of the mouse button by the user that signifies the selection of the subsequent document section selection, the data structure will be automatically transmitted to the server computer for storage in the database therein. In this case, since the record ID has already been obtained, a request for a record ID need not be implemented prior to sending the data structure. The data in the data structure will be added to the record in the database indicated by the record ID in that data structure.

The use of the same record ID will only occur when the user makes a subsequent document section selection from the same primary document during the same web browsing session. That is, in the event that a user selects a different primary document for viewing with the primary document display program 16 (such as surfing the web to a different web page), then a document section selection from the new primary document will cause a new record ID request to be issued, such that the new document section from the new primary document will be stored in a different record (having a different record ID) than the previous document section selection. This record will also require a different document title and document location address, although the user key, folder name, and document type may be the same. If a user happens to navigate back to the original web page from which he has already marked and saved a document section(s), then this is considered to be the same web browsing session and subsequently selected data sections are saved using the same record ID previously obtained for that web page (in addition, the yellow highlighting used to indicate which text/images have been previously selected and stored is displayed to the user, as are previously generated user notes as further described herein). If, however, the user terminates the web browsing session by closing the web browser, then a new record will be generated (including a record ID request to the server computer) even if the user re-opens the original primary document 34 for viewing and selects another document section. In this case, even though the record has already been generated for this particular primary document 34, the system will treat the document section selection as requiring a new record to be generated for storage at the server computer. In this case, the user will be required to enter a document title that is different from the document title provide during the first document selection for this primary document even though it is the same primary document (since document titles must be unique for each record).

As a result of this process, a plurality of database records associated with the user are created on the storage medium, wherein each database record is associated with a unique record ID and includes a document section(s) selected from one of a plurality of primary documents and a document title uniquely identifying the document section. Of course, since it is envisioned that multiple users will implement this system, the database will have records associated with many different users, each being accessible as further described herein.

The content of a document section 36 may be text and/or images obtained from the primary document 34, and importantly will include the original formatting from the primary document 34. Thus, virtually anything may be selected as a document section and stored in a record in the database, and that information will retain its original formatting. Notably, items such as data tables and the like will be replicated without error by the present invention.

As indicated above, the user may also add a note 38 to the primary document 34 shown in the primary document viewing program 16, which is then included in a data structure 40 and transmitted to the server computer for storage therein. In particular, the user will select a toolbar button (further described herein) to enable entry of the note 38 in association with a selected document section 36. Once the user types the note 38, the primary document 34 shown in the primary document display program 16 is modified by having the saved note text inserted near the selected document section 36, with the note text delimited by special visual characteristics, such as special highlighting, text color, a dotted border, or the like. At the same time as the contents of the primary document display program 16 are refreshed to include the text of the note 38, the data structure containing the note 38 is saved to the central server computer in the same record as the associated selected document section 36. That is, a note 38 will not exist in isolation but must be stored in association with a document section 36 that the user has selected.

The user key mentioned above is the mechanism for ensuring that records are associated with the appropriate user for storage as well as retrieval. The user key is generated for the first time when the user first signs on to the system, which will be at the time of installing the document section acquisition program. There, the user will enter a user name and a password, which will be sent to the server computer over the network. The server will generate a unique user key and store it in the database along with other user information, and then transmit the user key back to the document section acquisition program. The user computer will save the user key for all subsequent data sessions with the server, for example by saving it in the WINDOWS registry or the like. The user is now signed in to the server and all data transmissions made to the server will include that user key to identify the data as being associated with that user. In the event that the user closes the browser window and terminates the session, the user will still be signed in to the server. As such, when the browser is opened at a later time, the user will not have to sign in and the document acquisition program will use the previously obtained user key for data transmissions. Since the user key is static and does not change from session to session, there is no need to generate a new user key at a later time.

The only time the user is signed out is when he affirmatively does so by selecting the Sign-Out option from the system tray icon. Then, in the event the user wishes to execute another session with the server, a sign-in window box appears so the user can enter his user name (also called the I-LIGHTER™ ID) and the password. This information is sent to the server computer, and the previously generated user key for that user is retrieved from memory and sent back to user computer for use as previously described. By having a sign-in/sign-out process, the user is able to use the system from different computers. For example, a user may use this invention on a computer at work, then sign out there, and then sign-in from his home computer later that day. Since it may be desirable for a user to only be able to interact with the server from one computer device at a time (i.e. have one session open at time), it is important in some embodiments to have the sign-in process herein described. The sign-in process described above is also applicable to the document viewing program. That is, when the user implements the document viewing program in order to retrieve document sections and notes from the server computer, the user key is used with each data transmission between the client device and the server computer as previously described.

Advantageously, the present invention enables modification of the primary document 34 displayed in the primary document display program 16 (i.e. highlighting of text/images and inserting notes), and provides for real-time transmission of the highlighted sections and user-added notes to the server computer.

In one embodiment of the invention, the document section acquisition process loads into the memory space of a running INTERNET EXPLORER using the standard Browser Helper Object programming model as known in the art. When enabled, the document section acquisition program loads a copy of the HTML script of the current web page and adds it to an in-memory database of all web pages visited in the current session. As the user makes document section selections, the background of the selected text and/or images is changed to yellow, signifying that the user has successfully highlighted them. The information to be transferred to the server computer 12 is retrieved from the IHTMLSelectionObject. The HTML object retrieved is processed to ensure that it can be successfully transferred and rendered in the client application and then added to an in-memory database of all currently selected objects on that page. Additionally the document acquisition module's “image” of that page is updated to reflect the highlighted state.

In addition, when a user “surfs the web” by retrieving another web page, and then goes back to a highlighted page (e.g. by using the browser's back function as known in the art), then the highlighting and notes inserted by the user are again displayed to the user for that browsing session. Since the document acquisition module maintains an in-memory database of selected information and their underlying HTML, when the system recognizes that a user has returned to a page that has had highlighting applied to it, it re-applies the HTML formatting to visually reflect previously selected (highlighted) sections.

The basic document section selection and note entry functionality having now been described, there are many additional functions and features that exist in the preferred embodiment of the present invention (such as note editing) that will be further described with respect to a specific example of the document section acquisition program further below. First, it will be instructive to describe the basic operation of another main component of the present invention, which is document section viewing and assembly via the document viewing program 24.

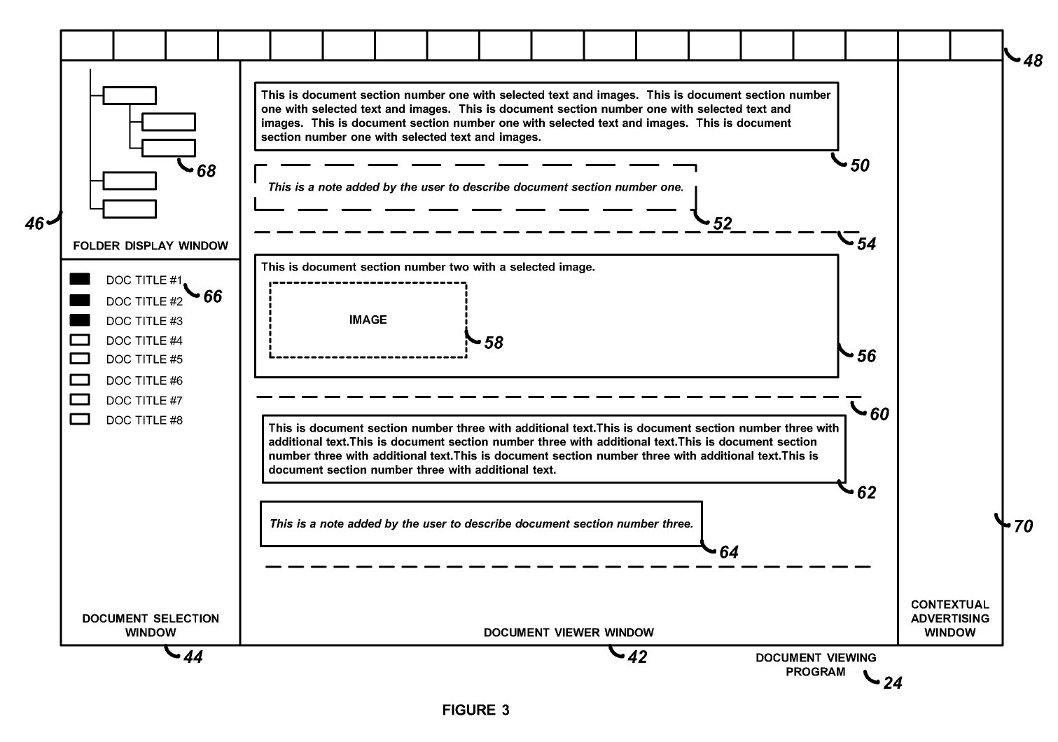

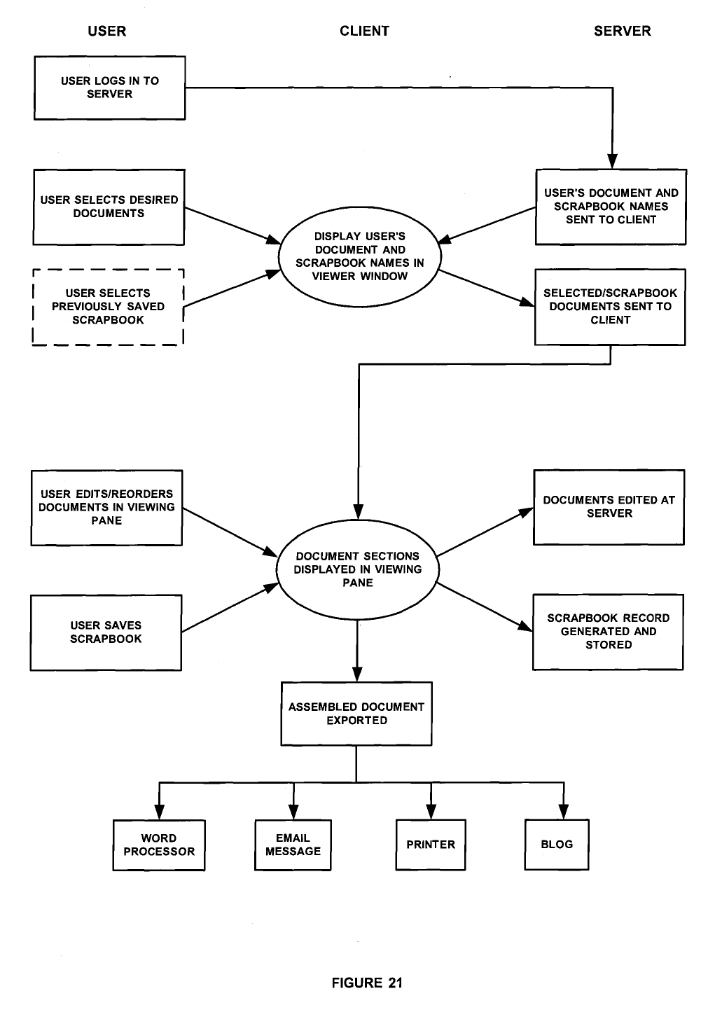

FIG. 3 is an illustration of a window display of a document viewing program 24 running on a user client computing device. The document viewing program 24 will provide three main window components (sometimes referred to as panes), which are the document viewer window 42, the document selection window 44, and the folder display window 46. Another section, a contextual advertising window 70, is also present in a non-enterprise or consumer version as further described herein. A document viewing toolbar 48 is also provided at the top of the display to provide various functions and controls to the user. Once the user has logged in to the system, and with further reference to the flowchart of FIG. 21, the user will be able to view all of the document sections and notes previously stored in the server computer 12 that are associated with his user key (e.g. those he created or those which were created by another user that he can view via sharing permissions). The user may control which document sections and notes are displayed in the document viewer window 42 by selecting various document titles 66 from the document selection window. In a simple embodiment, the user may have only one folder designated for storage of his document sections (for example, “My Folder”). By selecting this folder from folder display window 46, the document title of each of the document sections (and associated notes) that were previously stored in the database at server computer 12 in association with that folder will be sent from the server computer 12 to the document viewing program 24 for display in the document selection window 44. The selection of the desired document title 66 from the document selection window 44 causes the document viewing program 24 to issue a request for the document sections (and notes, if any) contained in the record associated with the selected document title 66 from the database 30 in server computer 12. The server computer 12 receives the request and retrieves the associated document sections and notes from the database, and then sends that information to the document viewing program 24. The document sections and notes are then displayed consecutively in the document viewer window. Thus, as shown in FIG. 3, the user has selected document title #1, document title #2, and document title #3 from the list of document titles available from folder 68. As a result, document section 50 and associated note 52, which were previously stored in the same record as document title #1, are retrieved from the database and displayed at the top of the document viewer window 42. Likewise, document section 56 which contains an image 58 (there is no associated note here), which was previously stored in the same record as document title #2, is retrieved from the database and displayed next in the document viewer window 42, separated from the previous selections by a dotted line 54. Finally, document section 62 and associated note 64, which were previously stored in the same record as document title #3, are retrieved from the database and displayed next in the document viewer window 42. Likewise, this is separated from the previous selections by a dotted line 60.

By selecting a different folder from the folder display window 46, different document titles 66 will be displayed in the document selection window 44 based on the folder name assigned to the document sections when they were selected by the user in the document section acquisition process previously described. The user may select document titles as desired, and the associated document sections and notes will be retrieved from the database and concatenated to the document sections and notes already on display in the document viewer window 42 (regardless of which folder they are selected from).

Thus, the present invention allows a user to select pieces of desired information and store them in a remote location, accessible at a later time via any user client device capable of running the document viewing program. For example, a user may be doing a research project and may store pieces of information of interest for later use, by simply blocking out the information with the mouse and having it automatically uploaded to the database in a single user action. This is highly advantageous over the prior art, which would require a user to cut and paste pieces of information in a separate document, then store it in a separate action, then manually edit it in a program such as a word processing program.

The basic document section retrieval and viewing functionality having now been described, there are many additional functions and features that exist in the preferred embodiment of the present invention (such as scrapbooks) that will now be further described with respect to a specific example of the present invention.

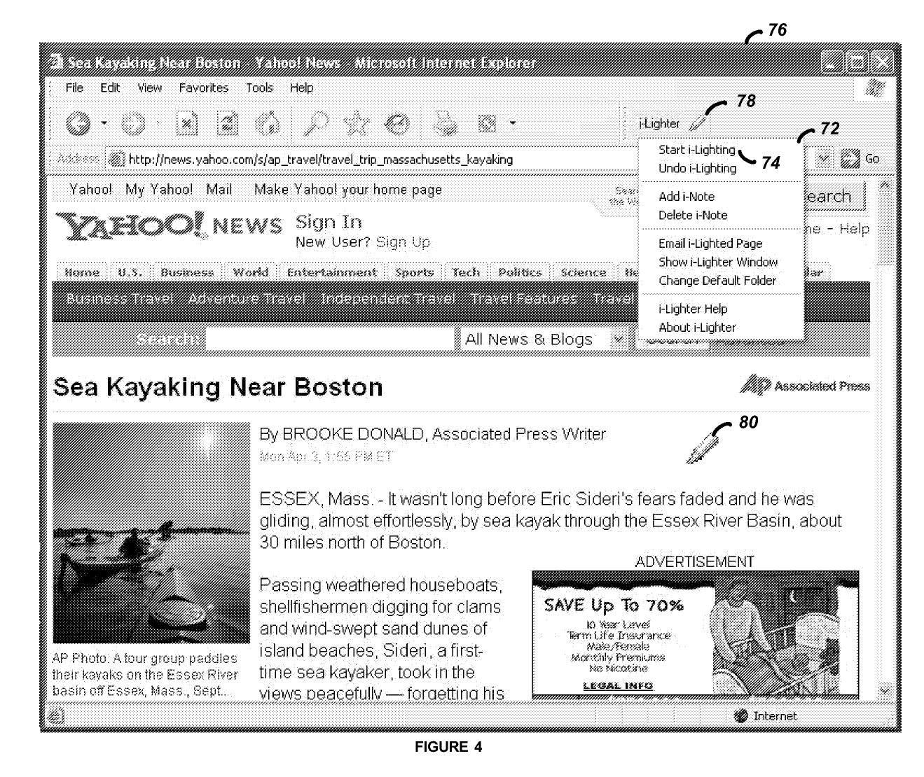

In the detailed example shown in FIG. 4, a primary document obtained from a primary document server 28 is shown as a web page 76, which loaded into a browser window of the primary document display program. Shown in this example is the use of the MICROSOFT INTERNET EXPLORER browser, but the present invention is applicable to any type of browser application. The browser window has a web page 76 entitled “Sea Kayaking Near Boston—Yahoo! News” loaded for display, which contains an article on Sea Kayaking Near Boston obtained from the YAHOO news web site. The document section acquisition program 20, known commercially as I-LIGHTER™, is integrated with the web browser such that the browser window 76 will now have an I-LIGHTER™ selection toolbar button 78 available for user selection at any time.

User selection of the I-LIGHTER™ button 78 will cause a drop down I-LIGHTER™ menu 72 to be displayed to the user, as shown in FIG. 4. In a preferred embodiment, I-LIGHTER™ menu 72 includes the functions “Start I-LIGHTING™” 74 (which changes to a “Stop I-LIGHTING™” option after being selected), “Undo I-LIGHTING™”, “Add I-NOTE™”, “Delete I-NOTE™”, “Email I-LIGHTED page”, “Show I-LIGHTER™ Window”, “Change Default Folder”, “I-LIGHTER™ Help”, and “About I-LIGHTER™”.

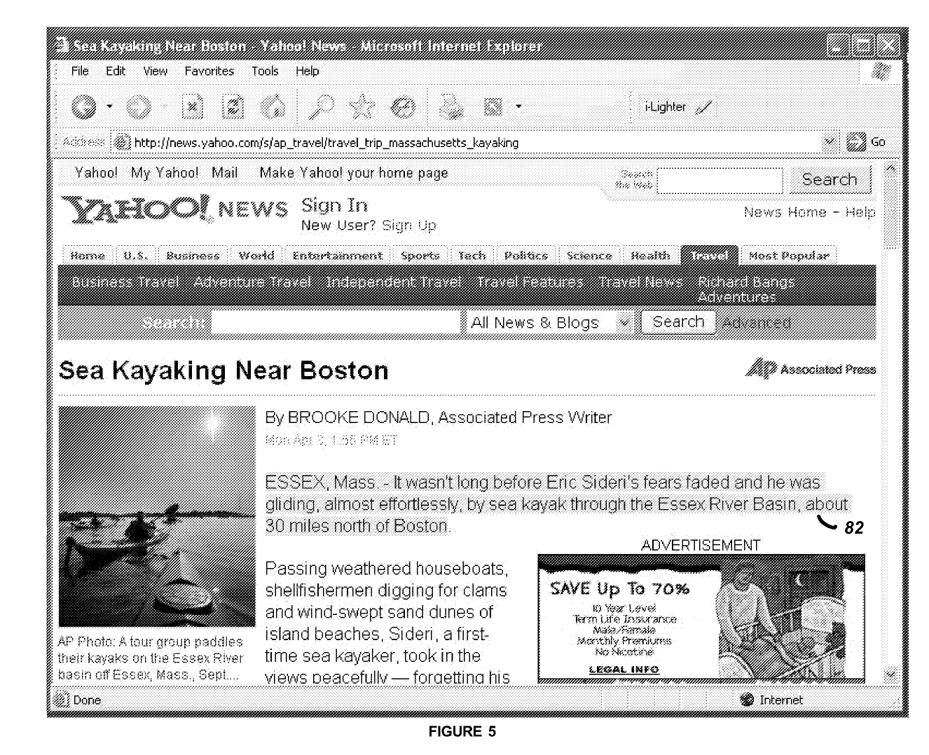

To begin the process of document section selection (also referred to as I-LIGHTING™ or highlighting), the user uses a mouse pointer to select the “Start I-LIGHTING™” option 74 of I-LIGHTER™ menu 72, which changes the mouse pointer to highlighting pointer 80 while the pointer hovers anywhere over the document 76 to be highlighted. The user can then select the desired document section with a single user action such as click-drag-release (as previously described) over the desired section. In this example, the user selects the text section 82 as indicated in FIG. 5. As previously described, as soon as the document section 82 is selected, document section acquisition program 20 automatically causes the document section 82 to be transmitted in a data structure 40 to the server computer 12 for storage therein. The highlighting pointer 80 remains the active pointer while the focus is on the web browser (the primary document display program 16) until such time as the user selects the “Stop I-LIGHTING™” function from I-LIGHTER™ menu 72. It should be noted that some third-party applications (such as MICROSOFT Word) have highlighting functions that are separate and distinct from the highlighting and document section selection functions of the present invention. In a preferred embodiment, highlighting pointer 80 is indicated by a different icon than the highlighting pointer of any third-party application, and highlighting pointer 80 is indicated by a different icon if the highlighting function of the third-party application is simultaneously enabled. In an alternate preferred embodiment, selecting the “Start I-LIGHTING™” function from I-LIGHTER™ menu 72 within a particular primary document display program 16 deactivates any native highlighting function which was previously active within that primary document display program, and native highlighting remains automatically disabled for the duration of the time that the highlighting function of I-LIGHTER™ menu 72 is enabled.

In the preferred embodiment, the highlighting function of I-LIGHTER™ menu 72 does not interfere with non-highlighting functions of third-party applications, so the ability to scroll text, etc. remains available to the user while highlighting. The highlighting function of the present invention is controlled separately within each I-LIGHTER™-augmented primary document display program. Thus, the highlighting function of the present invention might be turned on in INTERNET EXPLORER, while being turned off in ADOBE ACROBAT Reader.

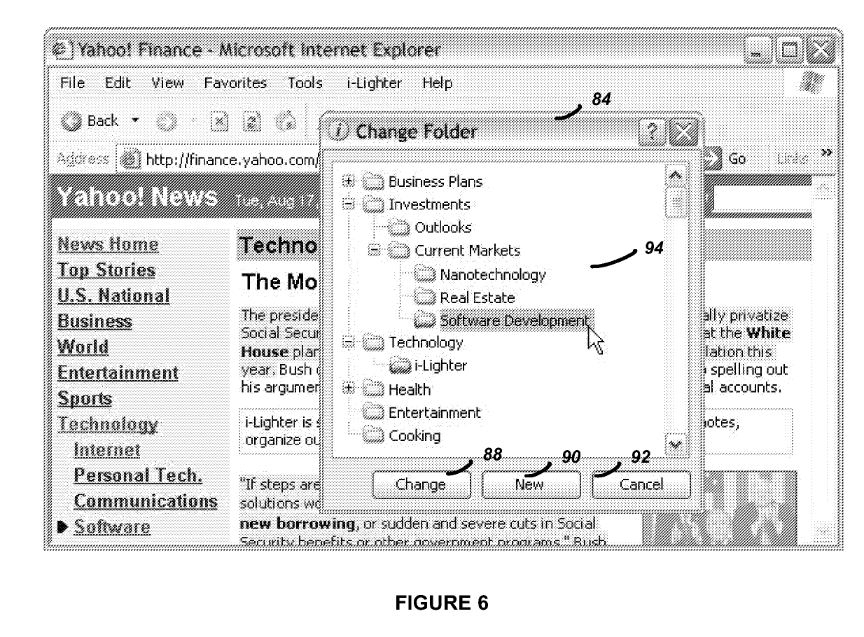

In the preferred embodiment, the first time a user selects a document section 82 from a web page 76 after a given instance of launching the web browser, the user is prompted to choose which of the user's folders on the server computer 12 the user wishes to associate with the saved document section (the default folder). Subsequently, any document sections selected and saved from within the web browser to the server computer 12 will go into the default folder initially selected, unless the user utilizes the “Change Default Folder” function of I-LIGHTER™ menu 72 to change the default folder for which document sections should be saved from that particular application. In a preferred embodiment, selecting the “Change Default Folder” function of I-LIGHTER™ menu 72 brings up Change Folder window 84 depicted in FIG. 6. The user may either choose an existing folder in folder tree 94 (by clicking on the folder and then clicking Change button 88), or the user may create a new folder. To create a new folder, the user may select any folder which is within the folder in which the new folder is to be created, and then click New button 90, which will create the desired new folder in folder tree 94. The new folder can then be re-named by clicking and typing as is customary in the MICROSOFT WINDOWS operating system. Should the user change his or her mind and not wish to change the default folder for storing annotated documents, the user can click Cancel button 92, which will close Change Folder window 84.

In a preferred embodiment, different default folders can simultaneously be defined for saving document sections to the I-LIGHTER™ server from different primary document display programs. The user can select whether the default folder associated with a particular primary document display program will be assumed to stay the same between times that third-party application is closed and re-opened, or whether the user should be prompted to re-choose the default folder each time a document section is saved after the primary document display program has been re-launched, or whether the user should be prompted to acknowledge the current default folder (or choose a new one) each time a particular document section is saved for the first time.

In an optional embodiment, the functions of I-LIGHTER™ menu 72 are also available to the user through the right-click menu of the mouse, and through assignable keyboard shortcuts.

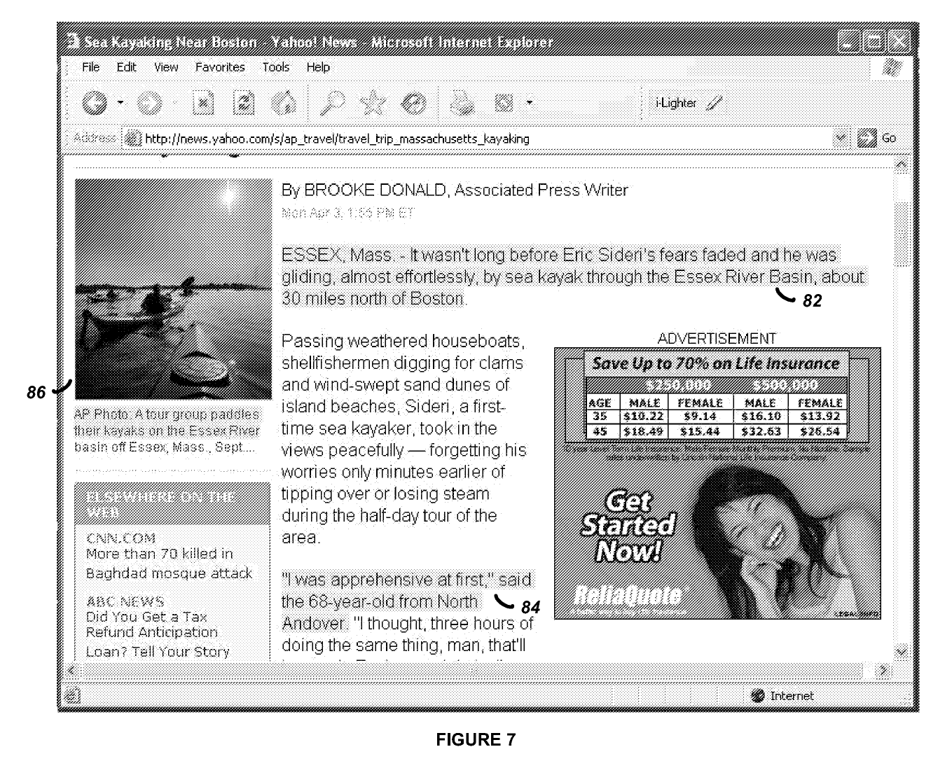

Once one section of text and/or graphics has been highlighted and selected, the user may continue selecting contiguous or non-contiguous sections of text and/or graphics by repeated click-and-drag operations with highlighting pointer 80. Each time the user finishes highlighting and selecting a new section of text and/or graphics, the document section acquisition program 20 automatically saves the subsequent document sections to the server computer 12 as previously described. FIG. 7 illustrates a web page 76 having three document sections selected for storage: the initial document section 82, a subsequent document section 84, and a subsequent document section 86 that includes an image as well as descriptive text. These selected documents sections are all transmitted to the server computer 12 for storage in the same record that has been previously defined.

A user may undo previously selected document sections from the web page 76 by selecting the “Undo I-LIGHTING™” option from menu 72. Then, the user may use the pointer 80 to block out the text that should be unselected. An instruction would then be sent from the document section acquisition program to the server computer to delete the selected text from the associated record.

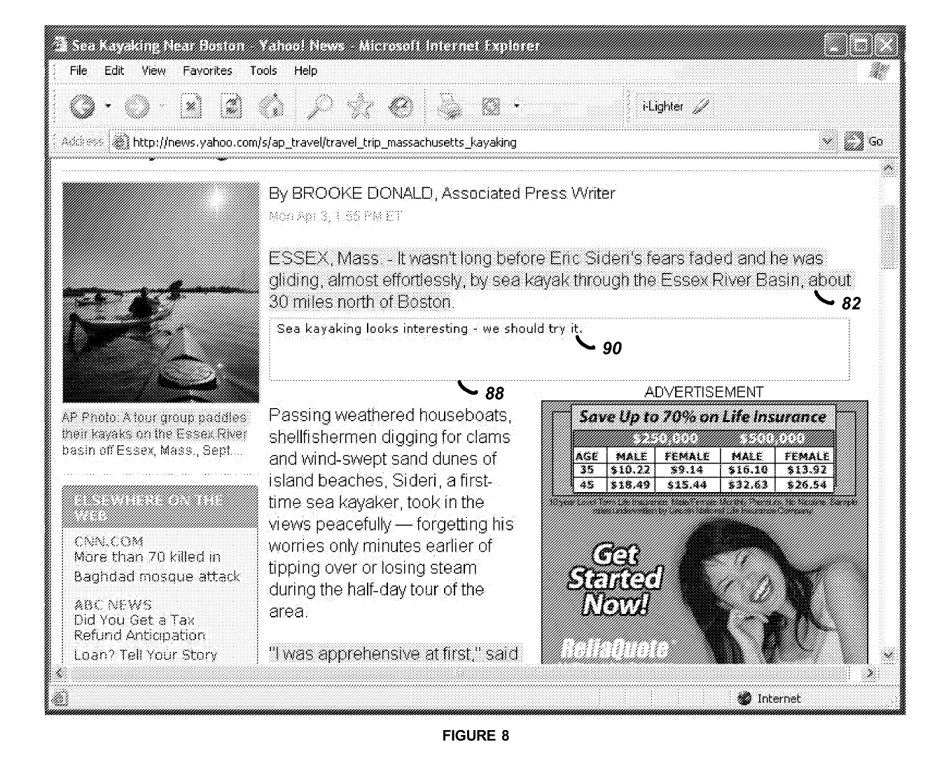

As previously described, a user may add a note (an I-NOTE™) in association with a selected document section as shown in FIG. 8. The user would select the “Add I-NOTE™” option from menu 72 and also select the highlighted document section 82 with which the note 88 should be associated and saved. In this example, the user creates the note 88 and an empty text box appears on the screen near the associated document section 82. The user may then type in the desired text 90, as shown in FIG. 8. Once the user has finished typing the text, and the note 88 no longer has the focus, then the text from the note will be sent to the server computer 12 in a data structure 40 as previously described and stored for subsequent viewing.

An I-NOTE™ may be deleted by selecting the “Delete I-NOTE™” option from menu 72 and then selecting the I-NOTE™ to be deleted, at which time a data structure will be sent to the server computer instructing it to delete the selected I-NOTE™.

In a preferred embodiment, the “Show I-LIGHTER™ Window” function of I-LIGHTER™ menu 72 brings up the document viewing program 24 in a separate window of the user computer as shown by the user device 22 in FIG. 1. This allows real time interactive retrieval, viewing, editing, and manipulation of the saved document sections as they are being selected and stored at the server computer 12. Although it is not required for the user to run the document viewing program 24 at the same time as the document section acquisition process occurs, many users will find this technique to be extremely useful.

As previously mentioned, the user is required to assign a document title to each document section that is selected for storage at the server computer 12. The first time the user selects a document section on a given web page, a dialog box requesting the user to enter a page name is displayed. The default page name inserted by the document section acquisition program 20 will be the title of the document, which in this example is “Sea Kayaking Near Boston—Yahoo! News”. The user has the option of accepting the default document title or entering a new one. In the event that the default title has already been used for that user (as indicated by the database 30 at the server 12), then the user will have to enter a different title since each record generated must have a unique document title.

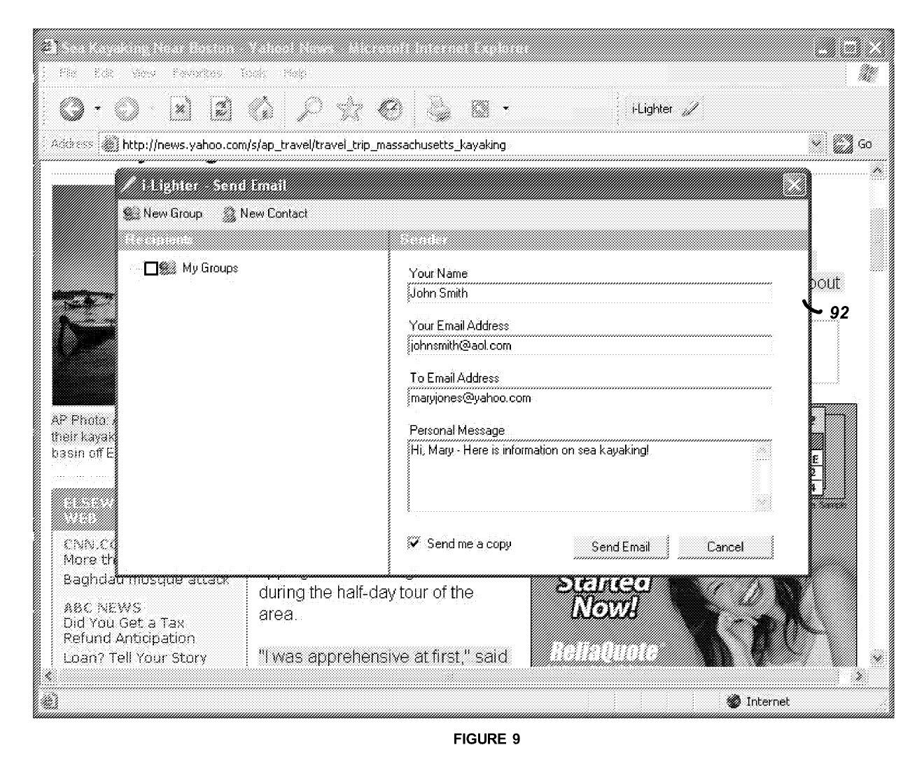

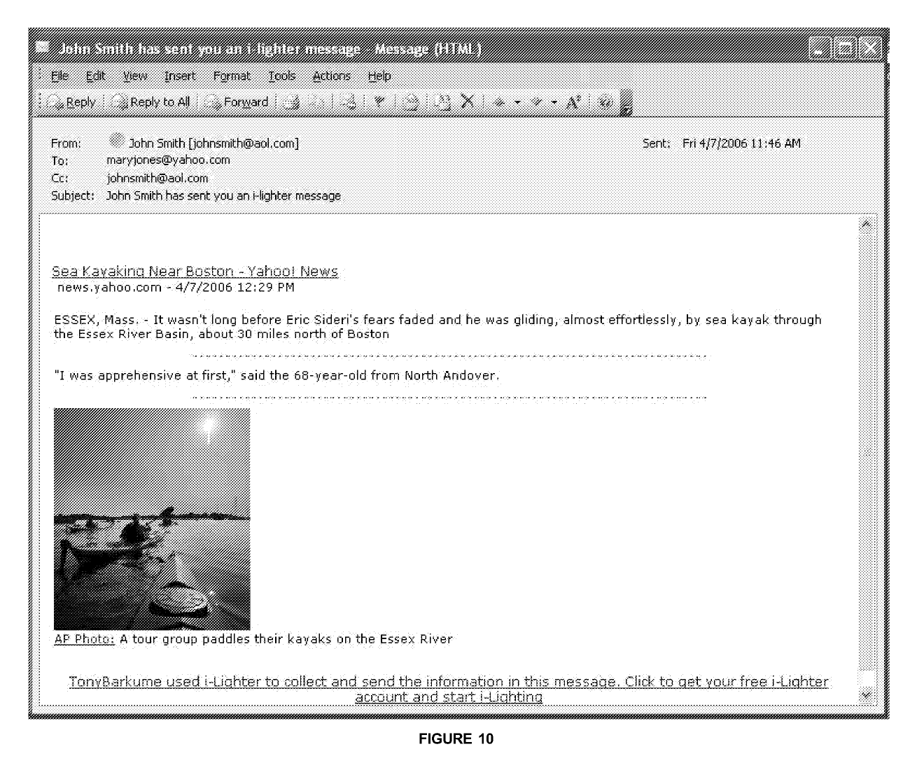

The “About I-LIGHTER™” function of I-LIGHTER™ menu 72 displays a standard “Help/About” type of dialog box, including copyright, trademark, and contact information; dynamically populated with content from server computer 12. Selection of the “Email I-LIGHTED™ Page” option from menu 72 will cause the email dialog box 92 to be displayed on the screen as shown in FIG. 9. As shown, this enables a user to specify a recipient of an email that the document section acquisition program will generate. The user may also specify his name, his email address, and a personal message. Since the document section acquisition program uses its own email capability, and does not rely on a separate email client such as OUTLOOK, it is important to supply this information so the recipient may make a reply email if desired. When the user selects this email option, a copy of the document sections and associated notes will be sent to the recipient, along with the personal message typed in the box. FIG. 10 illustrates the email that the recipient Mary Jones has received from the user John Smith. The subject line indicates the sender, and the body of the email contains the selected document sections as well as the URL to the original web page in case the recipient is interested in viewing the primary document.

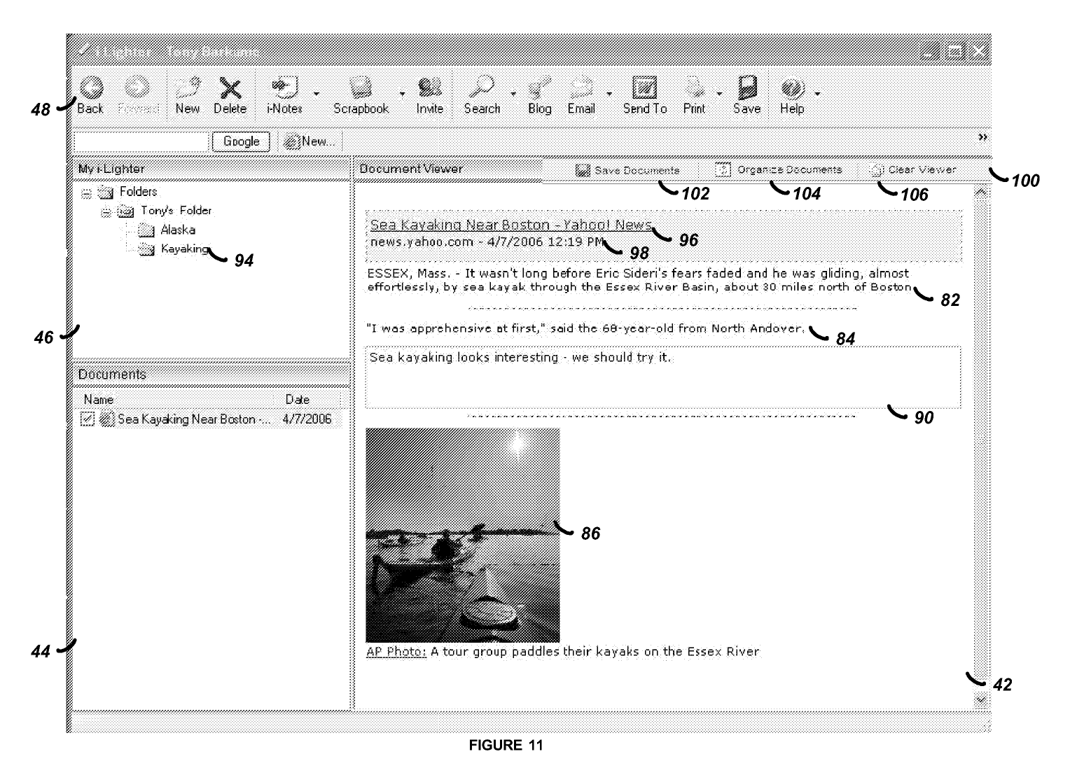

In the current example, FIG. 11 illustrates in detail the document viewing program 24 that shows the document sections selected by the user, stored at the server computer 12, and retrieved for viewing by the document viewing program. In FIG. 11, a single document title is provided—the one entitled “Sea Kayaking Near Boston—Yahoo! News” that was previously highlighted in FIG. 8. The folder display window 46 illustrates all of the folder names that are included in all of the records associated with the user, and displays them in a tree format as well known in the art. One folder will be the default folder for viewing, which in this example is the Kayaking folder 94. All of the document titles associated with folder 94 are then displayed in the document viewer window 44. As shown, only one document title is in the Kayaking folder. This is selected by the user (as indicated by the check mark), and then a request is made by the document viewing program to the server computer 12 to retrieve the document sections previously stored in the record associated with that document title. The document sections and notes from that record are received by the document viewing program and consecutively displayed in the document viewer window 42 as shown. Thus, the document viewer window will consecutively display the section 82, the subsequent section 84 and associated note 90, and the subsequent section 86 which includes an image. Also displayed is the URL 96 to the primary document and the timestamp 98 taken from the record.

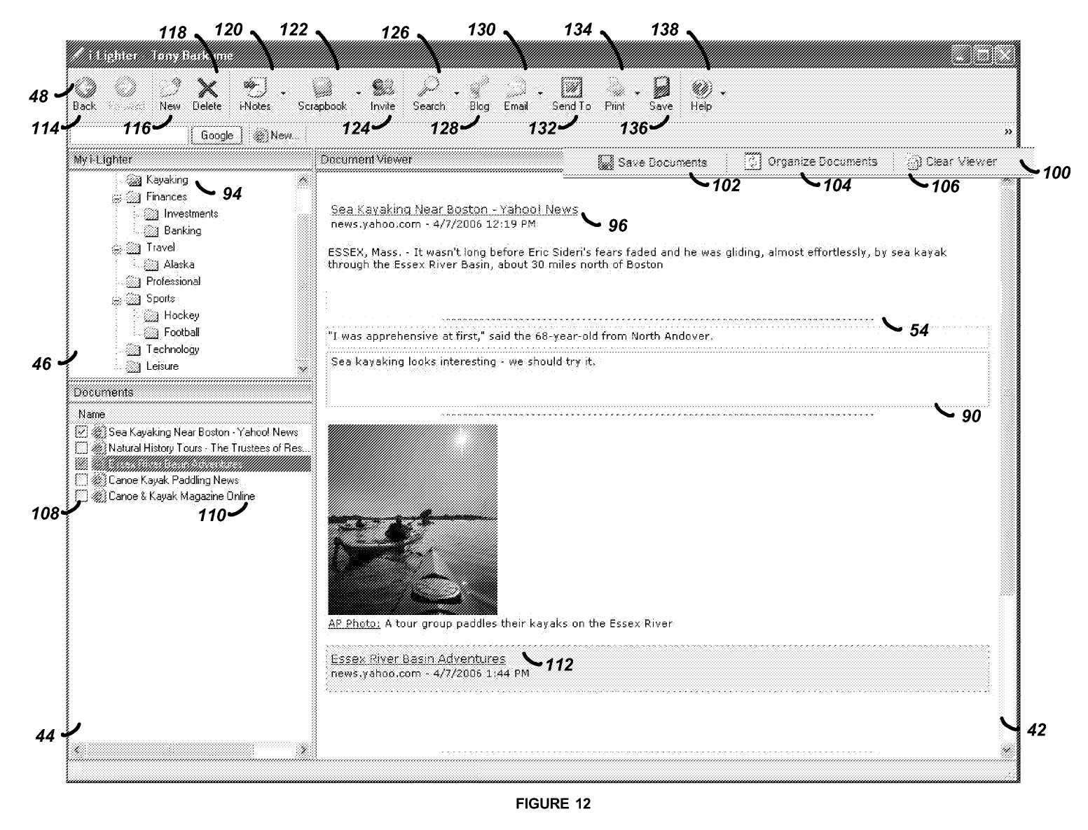

FIG. 12 shows a folder tree resulting from the production of a number of different document sections as described, for example after a user has used the present invention extensively. In this case the user has created many different folders, each of which may contain one or more document records. Here, the Kayaking folder 94 is open, showing the presence of five different document titles 110 for retrieval and viewing. The user has selected the first and third document titles from the list, and the associated document sections and notes are displayed in the document viewer window 42. If the user has configured the the document viewer window 42 to show I-NOTE™s (explained below) then the I-NOTE™s 90 associated with each document section will also be displayed.

Folders in folder display window 46 are nested and can be managed (moved) by dragging and dropping as known in the art. Folders can be added via the New button 116 and folders can be deleted via the Delete button 118 on toolbar 48. In a preferred embodiment, right-click context menu items provide known functions (New Folder, Cut, Paste, Delete, Rename, Set as Default Folder). Optionally, folders may be designated as shared in folder display window 46 and would be displayed with a “hand” icon under them instead of the standard folder icon (just as in the MICROSOFT WINDOWS file system). The standard view shows a user's own folders as shown in FIG. 12. However, if other users have shared folders with this user, he/she can click a down arrow, dropping the list to reveal other folder sets, e.g. Jerry's I-LIGHTER™ Documents, Bob's I-LIGHTER™ Documents, Denise's I-LIGHTER™ Documents. This will display the folders of that other user that are shared with the present user, instead of only the present user's own folders.

Document viewer window 42 displays the document sections associated with the document titles selected by check boxes 108. The user can select the I-NOTES™ control button 120 from the toolbar 48, and then select a “Show I-NOTES™” option to show the I-NOTES™ with the selected text and graphics document sections, or he can select a “Hide I-NOTES™” option to display only the selected text and graphics document sections selected via check-boxes 108. In a preferred embodiment, documents shown in document viewer window 42 each begin with a clickable URL link 96 to the primary document (selection of which loads the linked primary document page from the applicable web server into a new browser window), then continue with the selected sections from the primary document (highlighted text, or highlighted text and I-NOTE™s). If multiple, discontinuous sections of document sections from the primary document are shown, they are separated from one another by dotted separators such as dotted separator line 54.

The user may edit a note 90 displayed on the document viewer window 42, which will then be automatically modified in the record in the database on the server computer 12.

In a preferred embodiment, as the user navigates through various folders and checks some of check boxes 108 for each of a number of folders, document sections and I-NOTES™ from all document titles checked (in multiple folders) appear in document viewer window 42. In order to facilitate a user un-checking boxes in a folder no longer open, Back and Forward buttons 114 are provided on toolbar 48, which may be used to move through folders as they were chronologically viewed (for instance, when check-boxes for documents in those folders were checked). In a preferred embodiment, the context menu (right-click menu) of the mouse includes an option to un-check a given document (or all documents) (“Uncheck document from list”) when hovering over that given document's annotation text in document viewer window 42.

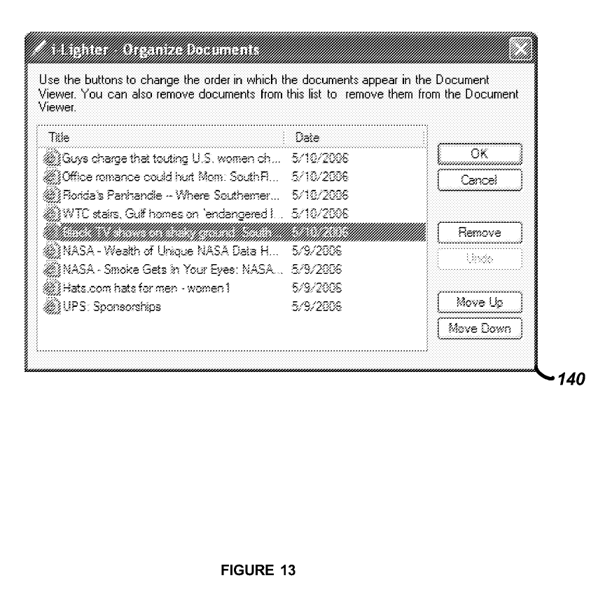

Another useful feature of the present invention provides the user with the ability to manipulate selected document sections via a document view mini-toolbar 100 as shown in FIG. 11. The user may select the Organize Documents button 104, which will display an Organize Documents window 140 as shown in FIG. 13. The Organize Documents window 140 provides a document map, which is a list of the document titles that are currently displayed as an assembled document (i.e. having the various document sections and associated notes) in the document viewer window. By viewing the document map via selection of button 104, the user may edit the assembled document in various ways. Selection of the document order controls “Move Up” or “Move Down” will move the selected document section up or down in the assembled document. Similarly, a user may remove a document section from the assembled document by using the Remove function provided. Although user may readily remove a document section by unselecting the check box for that document title from the document selection window, removal of a document section may be expedited by using the Remove function in the Organize Documents window.

After the user has assembled the document sections in the desired order in the document viewer window, he may save a scrapbook of the composite document by selecting the Scrapbook button 122 on the toolbar 48 or by selecting the Save Documents button 102 on the mini-toolbar. Scrapbooks are composite documents assembled from multiple document sections and notes in document viewer window 42, by viewing one or more saved document sections simultaneously by checking one or more of document title selection check boxes 108. Once a composite document has been assembled in document viewer window 42, it may be saved as a Scrapbook by clicking the Save function 136 of toolbar 48. When the Save function is clicked, a “Save Scrapbook” dialog box is opened, in which the previously saved Scrapbooks are listed along a name text entry box and Save and Cancel buttons. The user would enter a new scrapbook name or click an existing one to overwrite it, as may be desired. Similarly, the scrapbook being worked on may be closed by the clear viewer button 106 and an option to save is provided. In addition, a previously saved scrapbook may be opened by selecting the scrapbook button 122 as shown.

In practice, the scrapbook is saved as a new record in the database 30 at the server computer 12. The scrapbook record will comprise a list of record IDs associated with the selected document sections for that scrapbook, as well as information relevant to the order of display of those document sections. When, for example, a note associated with a document section included in the assembled composite document is edited, then all scrapbooks containing that document section and note will be revised in the same manner since the scrapbook is merely a reference to the document section(s) included therein. That is, when a previously-saved Scrapbook is opened, the record IDs are retrieved and then in turn used to retrieve the associated document sections and I-NOTES™, and then display them in the appropriate order in the document viewer window 42.

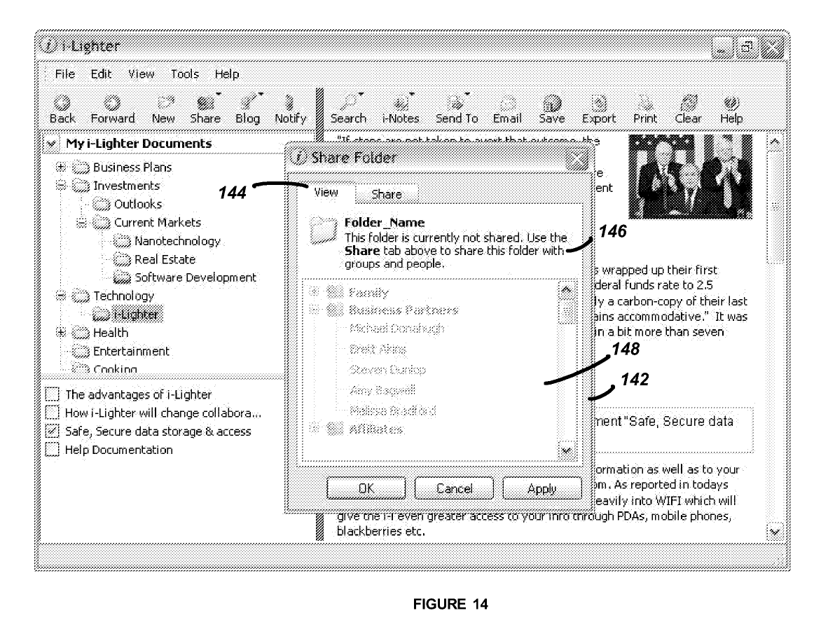

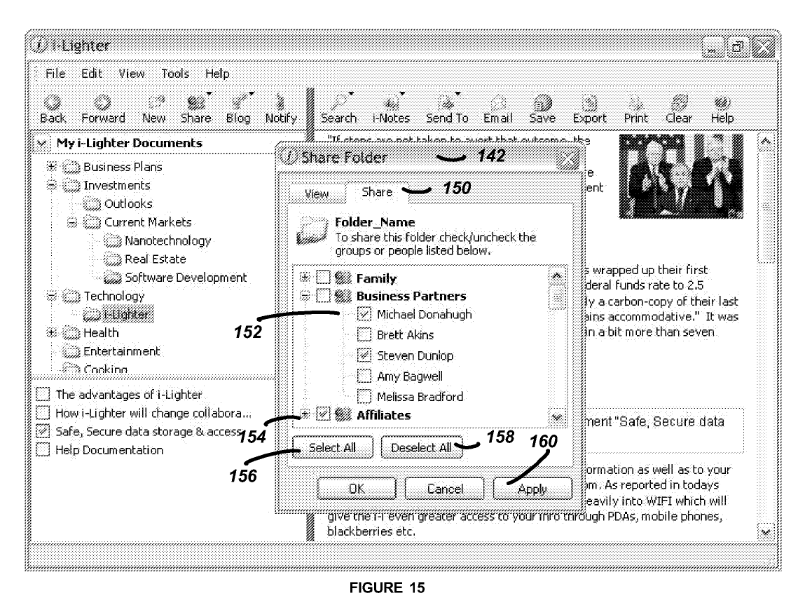

In a preferred embodiment, folder sharing permissions are controlled through an interface accessed through a Share Folder option of a share menu, which is accessed through an optional share button of toolbar 48 (not shown). Selecting the Share Folder option brings up Share Folder window 142 as shown in FIG. 15, with View tab 144 selected. The information in View tab 144 refers to current sharing permissions for the folder currently selected in folder display window 46. If no sharing privileges have been set up for the selected folder, shared contact pane 148 will appear grayed out as in FIG. 14, and message 146 will notify the user that the selected folder is presently not shared, and instruct the user how to proceed if the user wishes to share the selected folder. The user may elect to share a currently unshared selected folder by clicking Share tab 140 as shown on FIG. 15, and selecting users (by checking check-boxes such as user check-box 152) and groups (by checking check-boxes such as group check-box 154). Once the desired individuals and groups have been selected, the user can activate sharing of the selected folder with the selected users and groups by clicking Apply button 160.

If a user wishes to un-share a particular selected folder, the user can click Deselect All button 158, and then Apply button 160. If the user wishes to share a selected folder with all contacts in his or her database, he or she may click Select All button 156 and then click Apply button 160.

In one embodiment, a public share option may be implemented, wherein folders may be designated to be public and thus shared with an accessible to any member of the system, without requiring specific user names to be associated as being shared with. For example, a doctor may designate a particular folder as being public, so that anyone can access what he has put into that folder such as medical information and the like.

Other functions of a few buttons on toolbar 48 are now discussed. Clicking the Print button 134 prints the composite document assembled in document viewer window 42 (with or without I-NOTE™s as selected by the user). A Print preview option is also provided as known in the art. Clicking the Clear Viewer button 106 allows the user to start over, clearing all document segments assembled in document viewer window 42, and un-checking documents which had been checked in the document selection window 44. Clicking the Help button 138 connects to latest Help documentation on the associated website.

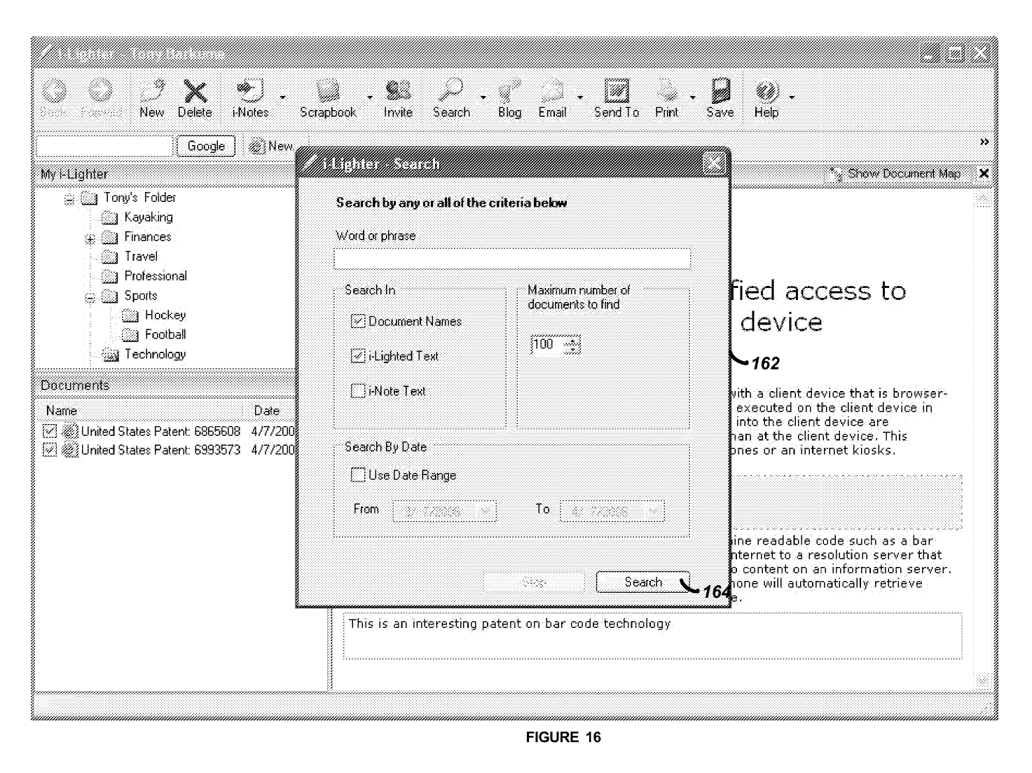

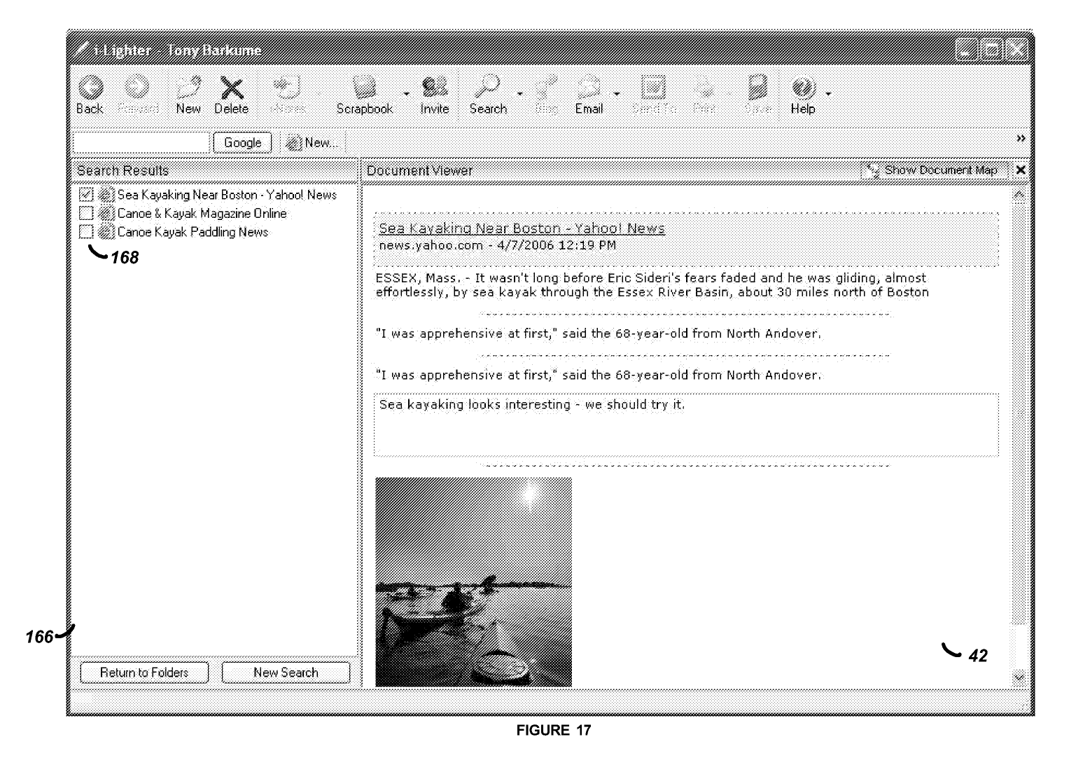

The present invention also features robust search functionality. Clicking the Search button 126 on the toolbar provides two options: New Search and View Last Search Results. Selecting New Search displays the Search popup window 162 as shown in FIG. 16. The Search function runs search engine software 32 on the I-LIGHTER™ server computer 12, which allows a user to search all saved records in the database to which he or she has access (his or her own document sections) plus all document sections owned by other users, which have been shared such that the user has access to them. The user enters the desired search word or phrase and indicates the sources in which to search (document names, “I-LIGHTED™ text” (i.e. saved sections), notes) as well as a date range. Once the search button 164 is selected from window 162, the documents from the server computer 12 found in the search are listed in a search results window 166 with check boxes 168 that allow the user to select which document sections should be displayed in the document viewer window 42, as shown in FIG. 17. Composite documents may be assembled from the selected search results by selecting and deselecting appropriate check boxes as previously described.

The Send To button 132 of toolbar 48 allows the composite document assembled in document viewer window 42 to be sent to a preconfigured application, such as MS WORD. By selecting this button, the document is sent to Word and may be edited, saved, etc. as known in the art. Other target applications such as Adobe Acrobat may also be provided, for example, in a drop down list.

The composite document that has been assembled may also be published to a blog by selecting Blog button 128 from the toolbar. This will open a new window that lists previously selected blogs (by name and URL) and the option to enter a new blog name and address. Once the desired blog is selected, the user selects a publish button that causes the assembled document to be published to the specified blog.

The composite document may also be sent via an email to a recipient by selecting the email button 130 from the toolbar 48. This activates a built-in email client that enables a user to enter a personalized greeting (if desired) as well as the recipient email address. Contact lists may be imported from OUTLOOK or OUTLOOK EXPRESS, for example. The user may then send the email, containing the assembled document as well as any greeting or message that may have been entered.

Document sections selected and automatically saved by a user contain information that is highly specific, identifying precisely the information that is of value to the user. The intelligence of the present invention therefore knows exactly which information on any document is important to each user because that user has identified the information of interest by selecting it for storage (i.e. by I-LIGHTING™ it).

This presents an opportunity to provide highly targeted advertising. Most other advertising methodologies display advertisements which might or might not be relevant. The present invention serves only relevant advertising because it bases its ads on information which the user has identified as relevant (i.e. has selected from a document).

In one example, a user visits CNN's Travel web site looking for cruise information, and then selects (highlights) a paragraph about the Princess Cruise to Alaska. Using standard contextual or behavioral analytic tools, an advertiser would know only that the user is interested in cruises. Using the intelligence of the present invention, an advertiser knows that the user is interested in the Princess Cruise to Alaska because he/she has identified it by highlighting (selecting) it for storage and retrieval.

The present invention stores each user's data in individual accounts on the central server computer 12. As each user continues to select text and images, the system builds a profile which pinpoints specific areas of interest determined over time. Using standard analytic tools, the present invention can then provide personalized advertising to each user, advertisements which cater to demonstrated interests. These advertisements are displayed to the user in the contextual advertising window 70 of FIG. 3.

In another example, a user of the present invention highlights a section from a web page about a hotel in Hawaii. He can immediately (or at a later time) be served an ad from that very hotel, or ads from related resources (discount flights, package tours, etc).

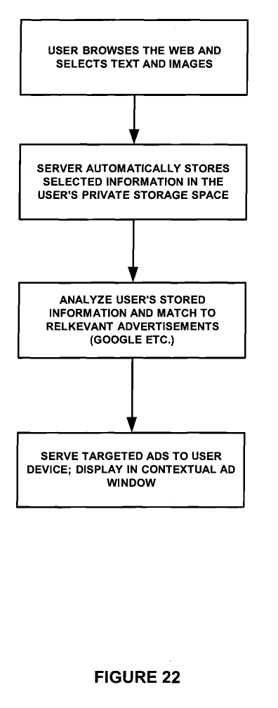

This aspect of the invention is illustrated in the flowchart of FIG. 22.

We will refer to certain embodiments of the present invention as the Enterprise I-LIGHTER™ System. In a preferred embodiment of the Enterprise I-LIGHTER™ system, I-LIGHTER™ central server 12 is a server computer owned and/or operated by the customer, and network 14 will typically be a corporate intranet. In preferred embodiments, revenues are derived by either outright sale of Enterprise I-LIGHTER™ software to corporate customers, or monthly or yearly rental enforced through methods such as periodic encrypted automated license renewal via the Internet. Officers of corporations may employ free-test-indexing and annotation extraction engine 1924 to learn about or track activities of employees using the Enterprise I-LIGHTER™ System. It is anticipated that some potential users of the Internet-based non-enterprise I-LIGHTER™ system may not wish to become users if they know that their interests are being tracked by free-text-indexing annotation extraction engine 1924, and it is anticipated that such users may be willing to pay a monthly fee for basic I-LIGHTER™ features and functionality. A preferred embodiment of the non-enterprise I-LIGHTER™ System therefore offers users the option of paying a monthly fee for I-LIGHTER™ service which does not deliver advertising and does not track users' interests.

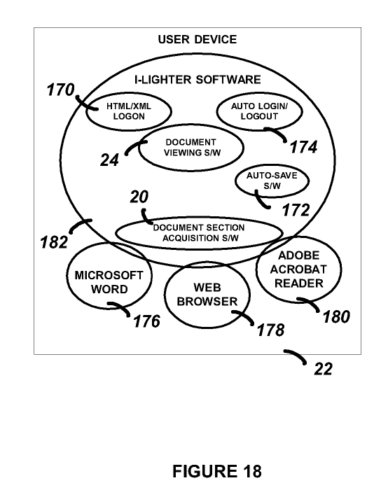

FIG. 18 is a more detailed block diagram of the user device of FIG. 1, showing distribution of software functions. As previously described, user device 22 may be one of a plurality of user devices which may interact with the server computer 12 via the network 14 (typically the Internet).

In the case of the preferred embodiment, user device 22 that will implement both the document section acquisition functionality as well as the document viewing functionality described herein, the user will install a client software bundle 182 onto his user device 22, which may be obtained via download, CD-ROM distribution, etc. The client software bundle 182 includes the document viewing software 24, auto-save module 172, and document section acquisition software 20, which add the I-LIGHTER™ features and functionality to third-party software programs such as web browser 178 (the preferred embodiment discussed herein), MICROSOFT Word 176, and ADOBE ACROBAT Reader 180. After the user has installed the I-LIGHTER™ software bundle 182 on his or her computer, he or she would likely go through a registration process as is typical in the art and begin to use the I-LIGHTER™ system.

In a preferred embodiment of the present invention, standard I-LIGHTER™ software bundle 182 adds the above described I-LIGHTER™ menu 72 and associated features and capabilities to the user's web browser, word processor, and document reader software through document section acquisition software 20 (which also may be referred to as a third party integration module since it integrates the present invention with virtually any third party document viewing program). The user's web browser (which might be Netscape, or the above example of INTERNET EXPLORER, or some other browser) is augmented by integrating web browser augmentation module with web browser software 178. The user's word processing software (such as MICROSOFT Word) is augmented by integrating word processor augmentation module with word processor software 176. The user's document reader software (such as ADOBE ACROBAT Reader) is augmented by integrating document viewer augmentation software with document viewer software 180. It should be noted that the implementation of the present invention does not rely on cooperation from third-party software manufacturers such as manufacturers of word processing software, manufacturers of web browsers, or manufacturers of document viewers. Rather, the I-LIGHTER™ third-party-software-augmentation modules are designed by taking advantage of standards such as are utilized in the MICROSOFT WINDOWS operating system and in the design of much third-party software to add I-LIGHTER™ menu 72 and its associated features. The I-LIGHTER™ toolbar may be selected for use in a manner similar to the example provided for the Internet browser described above.

In a preferred embodiment, saving of selected document sections and user-generated notes occurs automatically to database 30 within the I-LIGHTER™ server computer 12. In a preferred embodiment geared toward non-corporate consumer use, accounts with a standard feature set on the server computer 12 are free to the customer, and revenues are derived by delivering targeted advertising to customers.

Log-on to the I-LIGHTER™ server computer 12 is facilitated through log-on software 170, which includes a user interface which interfaces directly with the I-LIGHTER™ server computer 12. The sign on/log on process has been previously described above. In a preferred embodiment, when logging on to the server computer 12, the user is given the chance to select or change the default folder to which selected document sections and notes will be saved. In one preferred embodiment of the present invention, the login window features sponsored banner advertising. In a preferred embodiment intended for users who are the sole users of their computer devices, the auto-login/logout module 174 allows the user to configure automatic login to the I-LIGHTER™ server computer 12 whenever the I-LIGHTER™ software is started, and/or whenever an Internet connection is sensed, and/or at boot time.

The present invention has thus been described in detail with respect to several preferred embodiments, but is not limited to those embodiments and is more fully described in the claims appended hereto.

What is claimed is:

1. A method of selecting and saving information in a single user action comprising the steps of:
a. a user selecting with a computer input device a document section from a primary document displayed in a window of a primary document display program associated with a document section acquisition program;
b. assembling a data structure in memory comprising the selected document section; and
c. storing data from the data structure on a nonvolatile storage medium.

2. The method of claim 1 further comprising the step of transmitting the data structure over a computer network from the document section acquisition program to a server computer, wherein the nonvolatile storage medium is associated with the server computer.

3. The method of claim 2 wherein the step of selecting the document section comprises the steps of:
a. using a pointing device to place a cursor at a start location of the document section;
b. clicking an input button on the pointing device to begin the selection of the document section;
c. dragging the pointing device so that the document section is blocked out on the computer screen; and
d. releasing the input button on the pointing device;
whereby the document section is automatically assembled into the data structure and transmitted over the computer network to the server computer as a direct result of releasing the input button on the pointing device.

4. The method of claim 2 further comprising the steps of:
transmitting the document section from the storage medium to a document viewing program, and
displaying the document section in a document viewer window associated with the document viewing program.

5. The method of claim 4 wherein the document section acquisition program and the document viewing program are running on a single user client computing device.

6. The method of claim 4 wherein the document section acquisition program and the document viewing program are running on different user client computing devices.

7. The method of claim 2 further comprising the steps of
generating, in association with a selected document section in the primary document, a note comprising text input by a user,
assembling a data structure in memory comprising the note;
transmitting the data structure over the computer network to the server computer, and
storing the note from the data structure on the nonvolatile storage medium in association with the stored selected document section.

8. The method of claim 7 further comprising the steps of:
transmitting the document section and the associated note from the storage medium to a document viewing program, and
displaying the document section and the associated note in a document viewer window associated with the document viewing program.

9. The method of claim 8 further comprising the steps of:
providing a note display control function in association with the document viewer window;
the user selectively configuring the note display control function to disable display of the note while continuing to display the associated document section in the document viewer window; and
the user selectively configuring the note display control function to enable display of the note while continuing to display the associated document section in the document viewer window.

10. The method of claim 8 further comprising the steps of:
a user revising the note displayed in the document viewer window at the document viewing program;
transmitting the revised note to the server computer; and
storing the revised note on the storage medium in association with the stored document section.

11. The method of claim 8 further comprising the steps of:
generating, in association with the document section displayed in the document viewer window, a subsequent note comprising text input by a user,
assembling a data structure in memory comprising the subsequent note;
transmitting the data structure over the computer network to the server computer, and
storing the subsequent note from the data structure on the nonvolatile storage medium in association with the stored selected document section.

12. The method of claim 8 further comprising the steps of:
a user revising the note displayed in the primary document at the document section acquisition program;
transmitting the revised note to the server computer; and
storing the revised note on the storage medium in association with the stored document section.

13. The method of claim 2 wherein the data structure further comprises a record ID, and wherein data from the data structure is stored on the storage medium to create a database record associated with the record ID.

14. The method of claim 13 further comprising the steps of a user selecting a subsequent document section from the primary document;
assembling a subsequent data structure in memory comprising the subsequent document section and the record ID;
transmitting the data structure over the computer network to the server computer; and
storing data from the subsequent data structure in the database record associated with the record ID.

15. The method of claim 13 further comprising the steps of:
subsequent to the user selecting a document section from the primary document, transmitting a record ID request to the server computer; and
the server computer generating a record ID and providing the record ID to the document section acquisition program.

16. The method of claim 13 wherein a plurality of database records associated with the user are created on the storage medium, wherein each database record is associated with a unique record ID and comprises a document section selected from one of a plurality of different primary documents and a document title uniquely identifying the document section.

17. The method of claim 16 further comprising the steps of:
transmitting the document title from each of the plurality of records associated with the user to a document viewing program; and
displaying the document titles in a document selection window associated with the document viewing program.

18. The method of claim 17 further comprising the steps of:
providing a search control function window in association with the document viewing program;
the user selectively entering a search term into the search control function window;
a search engine using the search term to execute a search of any one or more of, as selected by the user from the search control function window,
the document titles,
the document sections, or
associated notes;
the search engine generating a list of matched document titles having criteria matching the search term as specified by the user;
sending the list of matched document titles to the document viewing program for display in the document selection window.

19. The method of claim 17 further comprising the steps of:
storing in each database record a folder name identified by the user as being associated with the document title in the record;
transmitting the folder name with the associated document title;
displaying the folder names in a folder tree format in a folder display window associated with the document viewing program; and
displaying the document titles in the document selection window in accordance with their associated folder names.

20. The method of claim 17 further comprising the steps of:
the user selecting a plurality of document titles from the document selection window;
for each document title selected by the user, sending a document request to the server computer for the document section associated with the document title in the storage medium;
for each document request, the server computer sending the requested document section to the document viewing program; and
consecutively displaying each document section received from the server computer as an assembled document in the document viewer window.

21. The method of claim 20 wherein each record further comprises a document location address indicating the location of the primary document associated with the document section.

22. The method of claim 21 wherein the document location address comprises a URL hyperlink.

23. The method of claim 21 wherein the document location address comprises a local pathname.

24. The method of claim 20 further comprising a document map viewable by the user in association with the document viewing program, said document map comprising a list of the titles of the document sections selected by the user and contained in the assembled document displayed in the document viewer window.

25. The method of claim 24 further comprising the step of the user changing the order of the selected document sections displayed in the assembled document by selecting one or more document order controls displayed with the document map.

26. The method of claim 24 further comprising the step of the user deleting at least one of the selected document sections displayed in the assembled document by selecting a delete function displayed with the document map.

27. The method of claim 20 further comprising the step of the user deleting at least one of the selected document sections displayed in the assembled document by unselecting the associated document title from the document selection window.

28. The method of claim 20 further comprising the user saving a scrapbook of the assembled document, the scrapbook comprising a list of each document title selected by the user and comprised in the assembled document, the scrapbook being saved in a record associated with the user and stored in the storage medium at the server computer.

29. The method of claim 20 further comprising the steps of
the user opening a previously saved scrapbook by selecting a scrapbook title from a list of available scrapbooks previously saved and displayed to the user in association with the document viewing program;
displaying a list of document titles from the selected scrapbook; and
dynamically assembling a document in the document viewer window by the steps of:
sending a document section request to the server computer for the document section associated with each document title in the storage medium;
for each document section request, the server computer sending the requested document section to the document viewing program; and
consecutively displaying each document section received from the server computer in the document viewer window as the assembled document.

30. The method of claim 20 further comprising the step of the user sending the assembled document to a word processing program.

31. The method of claim 20 further comprising the step of the user publishing the assembled document to a web site adapted to a dynamically accept text and images.

32. The method of claim 20 further comprising the step of inserting the assembled document to an email message and sending the email message to an intended recipient.

33. The method of claim 20 further comprising the step of the user printing the assembled document.

34. The method of claim 3 wherein the pointing device is a mouse.

35. The method of claim 3 wherein the pointing device is a touchscreen input.

36. The method of claim 3 wherein the pointing device is a pen input.

37. The method of claim 3 wherein the pointing device is a trackball.

38. The method of claim 3 wherein the pointing device is a trackpad.

39. The method of claim 1 wherein the document section comprises text from the primary document.

40. The method of claim 1 wherein the document section comprises an image from the primary document.

41. The method of claim 1 wherein the document section comprises formatting instructions from the primary document.

42. The method of claim 1 wherein the primary document display program comprises a web browser program.

43. A computer-based system for enabling a user to select and save information in a single user action, comprising a user client computing device comprising a computer input device and memory, said user client computing device running a primary document display program and a document section acquisition program in association with the primary document display program, the document section acquisition program adapted to:
enable a user to select, with the computer input device, a document section from a primary document displayed in a window of the primary document display program;
assemble a data structure in the memory comprising the selected document section; and
cause the data from the data structure to be stored on a nonvolatile storage medium.

44. The system of claim 43 further comprising:
a server computer, and
a computer network in selective communication with the server computer and the user client computing device,
wherein the nonvolatile storage medium is associated with the server computer, and the data structure is transmitted over the computer network from the document section acquisition program to the server computer for storage on the associated nonvolatile storage medium.

45. The system of claim 44 wherein the document section acquisition program is adapted to enable a user to select, with the computer input device, a document section from a primary document displayed in a window of the primary document display program by enabling the user to:
e. use a pointing device to place a cursor at a start location of the document section;
f. click an input button on the pointing device to begin the selection of the document section;
g. drag the pointing device so that the document section is blocked out on the computer screen; and
h. release the input button on the pointing device;
whereby the document section is automatically assembled into the data structure and transmitted over the computer network to the server computer as a direct result of releasing the input button on the pointing device.

46. The system of claim 44 wherein the server computer is adapted to transmit the document section from the storage medium to a document viewing program running on a user client computing device, and wherein the document viewing program is adapted to cause the document section to be displayed in an associated document viewer window.

47. The system of claim 46 wherein the document section acquisition program and the document viewing program are running on a single user client computing device.

48. The system of claim 46 wherein the document section acquisition program and the document viewing program are running on different user client computing devices.

49. The system of claim 44 wherein the document section acquisition program is further adapted to:
generate, in association with a selected document section in the primary document, a note comprising text input by a user,
assemble a data structure in memory comprising the note; and
transmit the data structure over the computer network to the server computer; and
wherein the server computer is further adapted to store the note from the data structure on the nonvolatile storage medium in association with the stored selected document section.

50. The system of claim 49 wherein the user client computing device is further adapted to run a document viewing program, and wherein the server computer is adapted to transmit the document section and the associated note from the storage medium to the document viewing program, and wherein the document section and the associated note are displayed in a document viewer window associated with the document viewing program.

51. The system of claim 50 wherein the document viewing program is further adapted to:
provide a note display control function in association with the document viewer window; and
enable the user to
selectively configure the note display control function to disable display of the note while continuing to display the associated document section in the document viewer window; and
selectively configure the note display control function to enable display of the note while continuing to display the associated document section in the document viewer window.

52. The system of claim 50 wherein the document viewing program is further adapted to:
enable the user to revise the note displayed in the document viewer window;
transmit the revised note to the server computer; and
wherein the server computer is further adapted to store the revised note on the storage medium in association with the stored document section.

53. The system of claim 50 wherein the document viewing program is further adapted to:
generate, in association with the document section displayed in the document viewer window, a subsequent note comprising text input by the user,
assemble a data structure in memory comprising the subsequent note;
transmit the data structure over the computer network to the server computer, and
wherein the server computer is further adapted to store the subsequent note from the data structure on the nonvolatile storage medium in association with the stored selected document section.

54. The system of claim 50 wherein the document section acquisition program is further adapted to:
enable the user to revise the note;
transmit the revised note to the server computer; and
wherein the server computer is further adapted to store the revised note on the storage medium in association with the stored document section.

55. The system of claim 44 wherein the data structure further comprises a record ID, and wherein data from the data structure is stored on the storage medium to create a database record associated with the record ID.

56. The system of claim 55 wherein the document section acquisition program is further adapted to:
enable a user to selecting a subsequent document section from the primary document;
assemble a subsequent data structure in memory comprising the subsequent document section and the record ID;
transmit the data structure over the computer network to the server computer; and
wherein the server computer is further adapted to store data from the subsequent data structure in the database record associated with the record ID.

57. The system of claim 55 wherein the document section acquisition program is further adapted, subsequent to the user selecting a document section from the primary document, to transmit a record ID request to the server computer; and wherein the server computer is further adapted to generate a record ID and provide the record ID to the document section acquisition program.

58. The system of claim 55 wherein a plurality of database records associated with the user are created on the storage medium, wherein each database record is associated with a unique record ID and comprises a document section selected from one of a plurality of different primary documents and a document title uniquely identifying the document section.

59. The system of claim 58 wherein:
the server computer is further adapted to transmit the document title from each of the plurality of records associated with the user to a document viewing program running on a user client computing device; and
the document viewing program is adapted to display the document titles in a document selection window.

60. The system of claim 59 wherein the document viewing program provides a search control function window that enables the user to selectively enter a search term; and
wherein a search engine running in association with the server computer uses the search term to execute a search of any one or more of, as selected by the user from the search control function window,
the document titles,
the document sections, or
associated notes; and
wherein the search engine generates a list of matched document titles having criteria matching the search term as specified by the user and sends the list of matched document titles to the document viewing program for display in the document selection window.

61. The system of claim 59 wherein each database record further comprises a folder name identified by the user as being associated with the document title in the record; and wherein the server computer is further adapted to transmit the folder name with the associated document title; and wherein the document viewing program is further adapted to display the folder names in a folder tree format in an associated folder display window and to display the document titles in the document selection window in accordance with their associated folder names.

62. The system of claim 59;
wherein the document viewing program is further adapted to enable the user to select a plurality of document titles from the document selection window; and for each document title selected by the user, to send a document request to the server computer for the document section associated with the document title in the storage medium; and
wherein the server computer is further adapted, for each document request, to send the requested document section to the document viewing program; and
wherein the document viewing program is further adapted to consecutively display each document section received from the server computer as an assembled document in the document viewer window.

63. The system of claim 62 wherein each record further comprises a document location address indicating the location of the primary document associated with the document section.

64. The system of claim 63 wherein the document location address comprises a URL hyperlink.

65. The system of claim 63 wherein the document location address comprises a local pathname.

66. The system of claim 62 wherein the document viewing program is further adapted to provide a document map viewable by the user, said document map comprising a list of the titles of the document sections selected by the user and contained in the assembled document displayed in the document viewer window.

67. The system of claim 66 wherein the document viewing program is further adapted to enable the user to change the order of the selected document sections displayed in the assembled document by selecting one or more document order controls displayed with the document map.

68. The system of claim 66 wherein the document viewing program is further adapted to enable the user to delete at least one of the selected document sections displayed in the assembled document by selecting a delete function displayed with the document map.

69. The system of claim 62 wherein the document viewing program is further adapted to enable the user to delete at least one of the selected document sections displayed in the assembled document by unselecting the associated document title from the document selection window.

70. The system of claim 62 wherein the document viewing program is further adapted to enable the user to save a scrapbook of the assembled document, the scrapbook comprising a list of each document title selected by the user and comprised in the assembled document, the scrapbook being saved in a record associated with the user and stored in the storage medium at the server computer.

71. The system of claim 62 wherein the document viewing program is further adapted to
enable the user to open a previously saved scrapbook by selecting a scrapbook title from a list of available scrapbooks previously saved and displayed to the user in association with the document viewing program;
display a list of document titles from the selected scrapbook; and
dynamically assemble a document in the document viewer window by the steps of:
sending a document section request to the server computer for the document section associated with each document title in the storage medium;
for each document section request, the server computer sending the requested document section to the document viewing program; and
consecutively displaying each document section received from the server computer in the document viewer window as the assembled document.

72. The system of claim 62 wherein the document viewing program is further adapted to send the assembled document to a word processing program.

73. The system of claim 62 wherein the document viewing program is further adapted to publish the assembled document to a web site adapted to a dynamically accept text and images.

74. The system of claim 62 wherein the document viewing program is further adapted to insert the assembled document into an email message and sending the email message to an intended recipient.

75. The system of claim 62 wherein the document viewing program is further adapted to print the assembled document.

76. The system of claim 45 wherein the pointing device is a mouse.

77. The system of claim 45 wherein the pointing device is a touchscreen input.

78. The system of claim 45 wherein the pointing device is a pen input.

79. The system of claim 45 wherein the pointing device is a trackball.

80. The system of claim 45 wherein the pointing device is a trackpad.

81. The system of claim 43 wherein the document section comprises text from the primary document.

82. The system of claim 43 wherein the document section comprises an image from the primary document.

83. The system of claim 43 wherein the document section comprises formatting instructions from the primary document.

84. The system of claim 43 wherein the primary document display program comprises a web browser program.
